(19) United States
(12) Patent Application Publication
(10) Pub. No.: US 2017/0139423 A1
(43) Pub. Date: May 18, 2017

(54) CONTROL SYSTEM AND METHOD FOR MULTI-VEHICLE SYSTEMS

(71) Applicant: KING FAHD UNIVERSITY OF PETROLEUM AND MINERALS, DHAHRAN (SA)

(72) Inventors: SAMI EL FERIK, DHAHRAN (SA); BILAL A. SIDDIQUI, DHAHRAN (SA)

(21) Appl. No.: 14/940,107

(22) Filed: Nov. 12, 2015

(51) Int. Cl. G05D 1/02

(52) U.S. Cl. CPC G05D 1/0295

(57) ABSTRACT

The control system and method for multi-vehicle systems provides nonlinear model predictive control (NMPC) to regulate navigation of multiple autonomous vehicles (mobile robots) operating under automatic control. The system includes an NMPC controller and an NMPC algorithm. The NMPC controller includes an optimizer, a state predictor, and a state estimator. Data compression is accomplished using a neural networks approach.

### BACKGROUND OF THE INVENTION

1. Field of the Invention

The present invention relates to robotics, and particularly to a control system and method for multi-vehicle systems that uses nonlinear model predictive control to regulate navigation of multiple autonomous vehicles operating under automatic control.

2. Description of the Related Art

Researchers have addressed multi-vehicle control by implementing a potential fields formation control strategy, but they considered a point mass robot. What is needed, however, is to extend the fields formation control strategy to make one of the robots lead the others in an unknown environment, and at the same time, have all the agents in the fleet keep their formation shape, based on the potential fields.

Thus, a control system and method for multi-vehicle systems solving the aforementioned problems is desired.

### SUMMARY OF THE INVENTION

The control system and method for multi-vehicle systems provides nonlinear model predictive control (NMPC) to regulate navigation of multiple autonomous vehicles (mobile robots) operating under automatic control. The system includes an NMPC controller and an NMPC algorithm. The NMPC controller includes an optimizer, a state predictor, and a state estimator. Data compression is accomplished using a neural networks approach.

These and other features of the present invention will become readily apparent upon further review of the following specification and drawings.

### BRIEF DESCRIPTION OF THE DRAWINGS

FIG. 1 is a block diagram illustrating the complete architecture of a NMPC controller for a single vehicle in a control system and method for multi-vehicle systems according to the present invention.

FIG. 2 are plots illustrating estimated and predicted state given constraints and control inputs.

FIG. 3 is a schematic diagram illustrating sets and feasible trajectories.

FIG. 4 is a graph illustrating a warm start ellipsoid.

FIG. 5 is a graph illustrating optimized terminal region with and without warm starting.

FIG. 6 is a graph illustrating optimization with tightened constraints.

FIG. 7 is a schematic diagram showing relationship between tightened constraints, terminal set, and minimum step size.

FIG. 8 is a graph illustrating optimal cost with various disturbance levels.

FIG. 9 is a graph illustrating boundary points of one step controllability set calculation.

FIG. 10 is a graph illustrating one step controllability set calculation, target set, and tightened constraints.

FIG. 11 is a graph illustrating recursive one step controllable sets, boundary points and trajectories between boundaries.

FIG. 12 is a graph illustrating optimizal cost for bounary points of I step controllable sets.

FIG. 13 is a graph illustrating robust output feasible set with tightened constraints.

FIG. 14 is a graph illustrating state trajectory in phase with terminal constraints.

FIG. 15 is a graph illustrating time evolution of states.

FIG. 16 is a graph illustrating control history.

FIG. 17 is a graph illustrating evolution of optimized cost function.

FIG. 18 is a block diagram illustrating distributed control of multi agent systems.

FIG. 19 is a block diagram illustrating possible computing systems implementing multi-agent control systems.

FIG. 20 is a schematic diagram illustrating trajectory compression and recovery using a neural network.

FIG. 21 is a schematic diagram showing collision course avoidance.

FIG. 22 is a schematic diagram illustrating successful collision course avoidance.

FIG. 23 is a graph illustrating fleet trajectory of three AUV.

FIG. 24 are plots illustrating states of agents connected in a strongly connected network.

FIG. 25 are plots illustrating normalized cost of vehicles and interagent distances.

FIG. 26 is a schematic diagram illustrating network topology of weakly connected team.

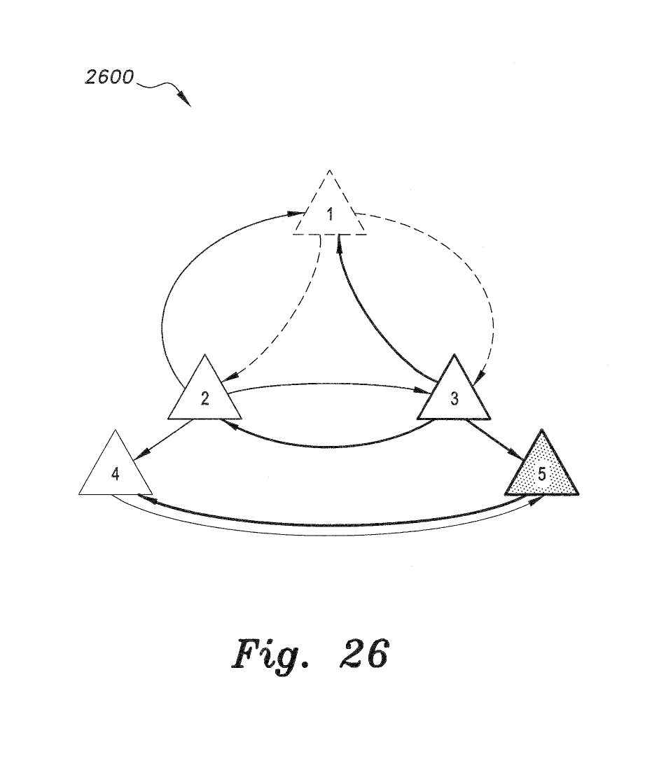

FIG. 27 is a graph illustrating fleet trajectory of 5 AUV.

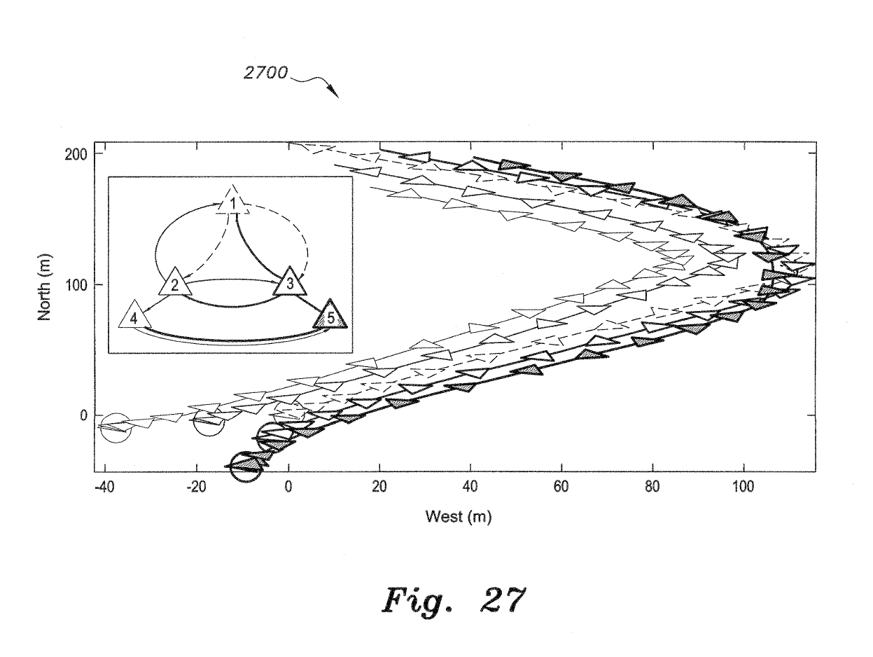

FIG. 28 are plots illustrating state of agents.

FIG. 29 is a plot illustrating small gain condition for a single agent.

Similar reference characters denote corresponding features consistently throughout the attached drawings.

### DETAILED DESCRIPTION OF THE PREFERRED EMBODIMENTS

At the outset, it should be understood by one of ordinary skill in the art that embodiments of the present method can comprise software or firmware code executing on a computer, a microcontroller, a microprocessor, or a DSP processor; state machines implemented in application specific or programmable logic; or numerous other forms without departing from the spirit and scope of the method described herein. The present method can be provided as a computer program, which includes a non-transitory machine-readable medium having stored thereon instructions that can be used to program a computer (or other electronic devices) to perform a process according to the method. The machine-readable medium can include, but is not limited to, floppy diskettes, optical disks, CD-ROMs, and magneto-optical disks, ROMs, RAMs, EPROMs, EEPROMs, magnetic or optical cards, flash memory, or other type of media or machine-readable medium suitable for storing electronic instructions.

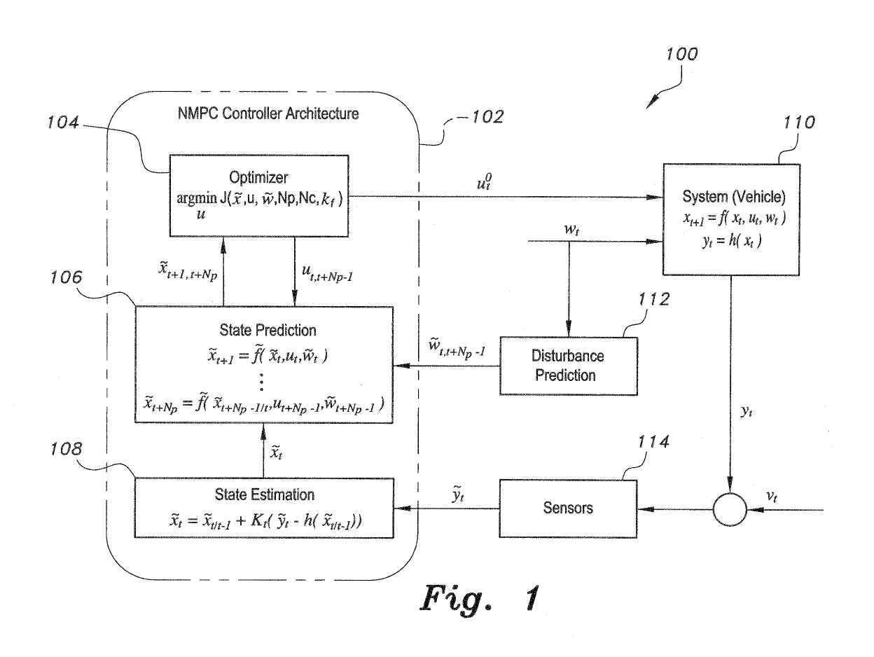

The control system and method for multi-vehicle systems provides nonlinear model predictive control (NMPC) to regulate navigation of multiple autonomous vehicles (mobile robots) operating under automatic control. The system 100 includes an NMPC controller and an NMPC algorithm. The NMPC controller includes an optimizer, a state predictor, and a state estimator. Data compression is accomplished using a neural networks approach. As shown in FIG. 1, the NMPC controller 102 includes an optimizer 104 in operable communication with a state predictor 106, which is in operable communication with a state estimator 108. Data compression is accomplished using a neural networks approach. The optimizer 104 has an output uₜ⁰ that feeds the multi-vehicles 110. A disturbance predictor 112 is also connected to the multi-vehicles 110 and shares with the multi-vehicles 110 a variable wₜ. The disturbance predictor 112 has an output \tilde{w}ₜ, t+Nₚ−1 that feeds the state predictor 106. A single coordinate position yₜ of the multi-vehicles 110 is combined with their velocity vₜ as an error signal that feeds sensors 114: The sensors 114 have an output \tilde{y}ₜ that feeds the state estimator 108.

The multi-vehicles 110 have nonlinear discrete-time dynamics characterized by the relation:

xₜ₊₁=f(xₜ, uₜ, wₜ), (1)

and the nonlinear output is:

yₜ=h(xₜ) (2)

Internal states xₜ, outputs yₜ, local control inputs uₜ and external inputs wₜ belong to the following constrained convex sets:

$$[ \begin{matrix}{x}_{t} ∈ X ⋐ {R}^{n} , & X , \{ x \text{:} {x}_{min} \leq x \leq {x}_{max} > 0 \} \\ {y}_{t} ∈ Y ⋐ {R}^{q} , & Y , \{ y \text{:} {y}_{min} \leq y \leq {y}_{max} > 0 \} \\ {u}_{t} ∈ U ⋐ {R}^{m} , & U , \{ u \text{:} {u}_{min} \leq u \leq {u}_{max} > 0 \} \\ {w}_{t} ∈ W ⋐ {R}^{p} , & W , \{ w \text{:} {w}_{min} \leq w \leq {w}_{max} > 0 \}\end{matrix} ] \qquad ( 3 )$$

External input w will be later used to model the information communicated by other members of the team or obstacles. In the current context of a single robotic vehicle (agent), we can utilize it to model any disturbance affecting the agent (e.g. wing gust, water current, turbulence etc.) or information about obstacle it has to avoid. The disturbance evolves according to the following nonlinear mapping:

wₜ₊₁=g(wₜ, Φₜ), (4)

where φ is an unknown input vector, possibly random. Since wₜ is not additive, it can also be used to represent plant uncertainty. The actual state of the system is xₜ, while the state predicted by a model at time t for future time instant t+l is \tilde{x}_{t,t+1}, assuming that the model of the system is not perfect, such that the nominal model actually used for state prediction is:

\tilde{x}ₜ₊₁=\tilde{f}(\tilde{x}ₜ, uₜ, \tilde{w}ₜ). (5)

Often, not all states are directly measurable, and when they are sensors may produce an output corrupted with noise and this lead to uncertainty. Therefore, the measured output is:

\tilde{y}ₜ=yₜ+ξ_{y}_{ₜ}, ξ_{y}≦|ξ_{y}_{ₜ}≦ξ̅_{y}|. (6)

Therefore, given the outputs measured by sensors, there is a need to estimate the states in a manner such that the effect of noise and uncertainty are mitigated. Assumption is that a mechanism of state estimation exists, such that the state is estimated with some bounded error ξₓ, such that:

\tilde{x}ₜ=\tilde{x}_{t|t-1}+Kₜ(\tilde{y}ₜ−h(\tilde{x}_{t|t-1})). (7)

where Kₜ is time varying nonlinear filter, which is assumed to be available and \tilde{x}_{t|t-1} is the prior estimate. In the present method, the assumption is that this filter exists, such that:

\tilde{x}ₜ=xₜ+ξₓ_{ₜ}, ξₓ≦|ξₓ_{ₜ}≦ξ̅ₓ|. (8)

Moreover, assume the existence of another estimator for w, which produces the estimate \tilde{w}, such that:

\tilde{w}ₜ=wₜ+ξ_{w}_{ₜ}, ξ_{w}≦|ξ_{w}_{ₜ}≦ξ̅_{w}|. (9)

Without exact knowledge of the evolution of w_{t,t+N}_{ₚ}, it can only have an approximation \tilde{w}_{t,t+N}_{ₚ} of it using a nominal model g̅(·) given by:

\tilde{w}ₜ₊₁=\tilde{g}(\tilde{w}ₜ), (10)

such that there is a bounded disturbance transition uncertainty due to disturbance model mismatch:

wₜ₊₁=g(wₜ, Φₜ)+e_{w}_{ₜ}, e_{w}≦|e_{w}_{ₜ}|≦ē_{w}. (11)

Similarly, it is assumed that system model mismatch leads to system transition uncertainty

$${e}_{{x}_{t}} {=}^{Δ} = \tilde{f (} {x}_{t} , {u}_{t} , {w}_{t} ) - f ( {x}_{t} , {u}_{t} , {w}_{t} )$$

such that:

\tilde{f}(xₜ, uₜ, wₜ)=f(xₜ, uₜ, wₜ)+eₓ_{ₜ}, eₓ≦|eₓ_{ₜ}|≦ēₓ. (12)

Now, due to uncertainty, the constraint sets (3) for x and w will be larger than constraints sets for \tilde{x}, and \tilde{w}, such that:

$${\tilde{x}}_{t} ∈ {\tilde{X}}_{t} ( {\overline{e}}_{x} , {\overline{ξ}}_{x} , {\overline{e}}_{w} , {\overline{ξ}}_{w} ) ⋐ X , {\tilde{y}}_{t} ∈ {\tilde{Y}}_{t} ( \overline{v} ) ⋐ Y , {\tilde{w}}_{t} ∈ {\tilde{W}}_{t} ( {\overline{ξ}}_{w} , {\overline{e}}_{w} ) ⋐ W . \qquad ( 13 )$$

Normally NMPC is used for state regulation, i.e., it will usually steer the state to the origin or to an equilibrium state xᵣ=r, where r is a constant reference. This is generally true for process industries. However, in mobile robotics, the control objective depends on the mission profile of the vehicle, as the target state may evolve over time, rather than being constant. Tracking and path tracking are two fundamental control problems in mobile robotics. For tracking problems, the objective is to converge to a time-varying reference trajectory x_{d}(t) designed separately. On the other hand, in path following applications, the objective is to follow a reference path parameterized by geometric parameters rather than time. The path following problem can be reduced to state regulation task. Therefore, the control strategy of MPC is explained using regulation problem as an example. Based on the control objective, let the vehicle have the finite-horizon optimization cost function given by:

$${J}_{t} ( \tilde{x} , u , \tilde{w} , {N}_{c} , {N}_{p} , {k}_{f} ) = {\sum }_{l = t}^{t + {N}_{c} - 1} [ h ( {\tilde{x}}_{l} , {u}_{l} ) + q ( {\tilde{x}}_{l} , {\tilde{w}}_{l} ) ] + {\sum }_{l = t + {N}_{c}}^{t + {N}_{p} - 1} [ ( {\tilde{x}}_{l} , {k}_{f} ( {\tilde{x}}_{l} ) ) + q ( {\tilde{x}}_{l} , {\tilde{w}}_{l} ) ] + {h}_{f} ( {\tilde{x}}_{t + {N}_{p}} ) , \qquad ( 14 )$$

where Nₚ and N_{c} are prediction and control horizons. Cost function (14) consists of transition cost h, terminal cost h_{f} and robustness cost q (due to the effect of external input). Control sequence u_{t,t+Np} consists of two parts u_{t,t+N}_{_{c−1}} and u_{t+N}_{_{c}}_{,t+N}_{_{p−1}}. The latter part is generated by terminal (also called auxiliary) control law u₁=k_{f}, (\tilde{x}ₗ) for l=N_{c} while the former is finite horizon optimal control u_{t,t+Np} which is a finite horizon optimal control problem (FHOCP) solution.

The optimal control sequence that minimizes the finite horizon cost of eqn. (14) is:

$$= {argmin}_{u ∈ U} {J}_{t} ( \tilde{x} , {\tilde{w}}_{t , t + {N}_{p}} , {u}_{t , t + {N}_{p}} , {N}_{c} , {N}_{p} ) , \qquad ( 15 )$$

subject to (1) nominal state dynamics eqn. (5); (2) nominal disturbance dynamics eqn. (10); (3) Control constraint eqn. (3) and the tightened constraint sets relation (13); and (4) terminal state being constrained to an invariant terminal set X_{f} ∈ \tilde{X}_{t+N}_{_{c}}, i.e.:

\tilde{x}ₜ₊ₗ ∈ X_{f}, ∀l=N_{c}, . . . , Nₚ. (16)

Suboptimal sequence u_{t,t+N}_{_{c−1}} satisfying the constraints of eqns (1), (3) and (16) is called feasible control. In other words, a control input is feasible if and only if it provides a feasible solution to the finite horizon optimal control problem. Hence if a control input is admissible (u ∈ U), it is not necessarily feasible. For a given state the set of feasible inputs is a subset of the admissible inputs. The loop is closed by implementing only the first element of u_{t,t+N}_{_{c−1}}⁰ at each instant, such that the NLMPC implicit control law becomes:

Θₜ( [symbol] )=uₜ⁰(\tilde{x}ₜ, \tilde{w}ₜ, Nₚ, N_{c}), (17)

and the loop dynamic becomes:

xₜ₊₁=f(xₜ, Θₜ( [symbol] ), wₜ)=f_{c}(xₜ, wₜ). (18)

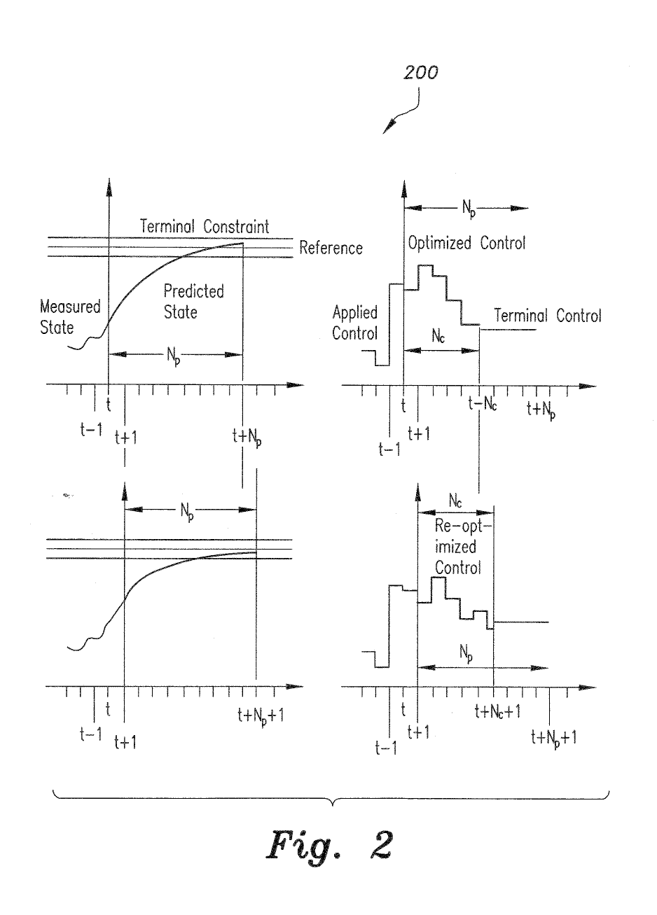

with closed loop nonlinear map f_{c}(x, w). This process is repeated every sampling instant, as illustrated in plots 200 of FIG. 2. The overall control architecture 100 is shown in FIG. 1. To summarize, at time t, current state is sampled and an estimate of the disturbance is made, then cost eqn. (14) is minimized over a finite horizon Nₚ, using N_{c} control adjustments and pre-computed terminal control law k_{f}, such that system constraints (1)-(3) are satisfied in addition to state remaining in an invariant terminal set X_{f}. Then the plant state is sampled again and the same optimization problem is solved again, yielding re-optimized control. Prediction horizon keeps being shifted forward and for this reason MPC is also called receding horizon control (RHC), though this is a slight abuse of notation (RH strategy along with model based optimization together forms the MPC strategy). The comprehensive strategy for robust nonlinear model predictive control is outlined in Table 1.

TABLE 1
Algorithm 1-Robust NMPC Control with Constraint Tightening

| | |
|---|---|
| 1: | Input nominal model \tilde{f}(\tilde{x},u,0), nominal constraints (3), receding |
| | horizon (RH) cost (14) and error bounds (7)-(12). |
| 2: | procedure OFFLINE OPTIMIZATION |
| 3: | Tighten constraints using Algorithm 2 for robustness |
| 4: | Determine optimized terminal set X_{f} and terminal control k_{f} using |
| | Algorithm 3 |
| 5: | Warm-start Algorithm 5 with Algorithm 4. |
| 6: | Determine One-step controllability set C₁(X_{f}) to ensure |
| | recursive feasibility using Algorithm 5. |
| 7: | Determine Robust output feasibility set X_{MPC} using Algorithm 6. |
| 8: | end procedure |
| 9: | Start system time at t, l = 0 |
| 11: | procedure (Online Optimization) |
| 12: | Measure outputs \tilde{y}ₜ₊₁ and disturbance \tilde{w}ₜ₊₁ |
| 13: | Estimate state \tilde{x}ₜ₊₁ and disturbance \tilde{w}ₜ₊₁ |
| 14: | Solve finite horizon OCP at t + l for control u_{t+1,t+1,t+N}_{_{c}}⁰ |
| 15: | Implement first element of optimized control uₜ⁰ |
| 16: | end procedure System clock advances, l = l + 1 |
| 17: | end while |

The two classes of optimization problems solved in Algorithm 1 are offline and online. This overall algorithm consists of various ingredient algorithms, described below.

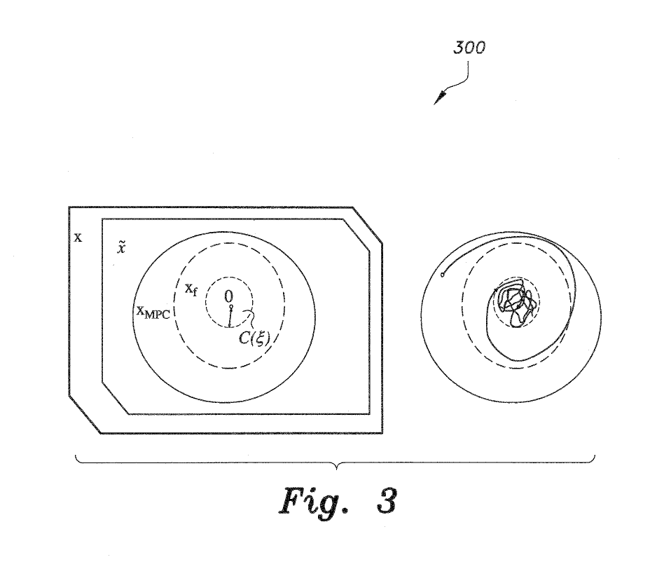

As shown in FIG. 3, diagrams 300 illustrate the sets introduced by relation (3) and feasible trajectories. State constraint set X, tightened constraint set [symbol] , terminal set X_{f} and uncertainty ball βⁿ(c) are shown. With actual constraints X and W, the tightened constraints are given by:

$$\begin{matrix}{\tilde{X}}_{t + l} {=}^{Δ} X ∼ {β}^{n} ( {\overline{ρ}}_{{x}_{t + l}} ) , and & ( 19 ) \\ {\tilde{W}}_{t + l} {=}^{Δ} W ∼ {β}^{n} ( {\overline{ρ}}_{{w}_{t + l}} ) , & ( 20 )\end{matrix}$$

for l=0, . . . , N_{P}, where ρ̅ₓand ρ̅_{w} are prediction error bounds defined using Lipschitz constants L** as:

$$\begin{matrix}{\overline{ρ}}_{{x}_{t + l}} {=}^{Δ} {L}_{fx}^{l} {\overline{ξ}}_{x} + {\overline{e}}_{x} \frac{{L}_{fx}^{l} - 1}{{L}_{fx} - 1} + {\overline{ξ}}_{w} {L}_{fw} \frac{{L}_{fx}^{l} - {L}_{gw}^{l}}{{L}_{fx} - {L}_{gw}} + {\overline{e}}_{w} \frac{{L}_{fw}}{{L}_{gw} - 1} ( \frac{{L}_{fx}^{l} - {L}_{gw}^{l}}{{L}_{fx} - {L}_{gw}} - \frac{{L}_{fx}^{l} - 1}{{L}_{fx} - 1} ) , & ( 21 ) \\ {\overline{ρ}}_{{w}_{t + l}} {=}^{Δ} {L}_{gw}^{l} {\overline{ξ}}_{w} + {\overline{e}}_{w} \frac{{L}_{gw}^{l} - 1}{{L}_{gw} - 1} , & ( 22 )\end{matrix}$$

Then, any (in general suboptimal) admissible control sequence u_{t,t+N}_{_{c}}₋₁ and terminal control u_{t+N}_{_{c}}_{,t+N}_{_{p−1}}=k_{f}(\tilde{x}_{t+N}_{_{c}}_{,t+N}_{ₚ}₋₁) that is feasible (\tilde{x}ₜ₊ₗ ∈ \tilde{X}ₜ₊₁ u_{t,t+N}_{_{p−1}} ∈ U,) and \tilde{w}ₜ₊ₗ ∈ \tilde{W}ₜ₊ₗ with respect to tightened constraints (21)-(22) applied to the actual system (1), guarantees the satisfaction of original constraints (3), i.e. xₜ₊ₗ ∈ X and wₜ₊ₗ ∈ W for l=0, . . . , N_{P} and xₜ ∈ X_{MPC}. The constraint tightening procedure is summarized in Table 2.

TABLE 2
Algorithm 2 Constraint Tightening

| | |
|---|---|
| 1: | Given (i) nominal models \tilde{f}(\tilde{x},u,\tilde{w})), \tilde{g} (\tilde{w}), (ii) uncertainty bounds |
| | ξ̅ₓ, ξ̅_{w}, ēₓ, ēₓw, and (iii) horizons N_{C}, N_{P}. |
| 2: | procedure CONSTRAINT TIGHTENING |
| 3: | Calculate Lipschitz constants of nonlinear maps \tilde{f}(\tilde{x},u,\tilde{w}) and |
| | \tilde{g} (\tilde{w}). |
| 4: | Calculate the prediction error bounds in (21) and (22). |
| 5: | Tighten the constraints by Pontryagin difference as given in |
| | (19)-(20). |
| 6: | end procedure |

Constraint tightening (19)-(20) is novel as it is the first time that such a variety of uncertainty contributions have been considered simultaneously. Remarkably, the external input is not a constant or random unknown as is usually assumed, but herein it is considered to evolve according to an uncertain nonlinear map. Besides, estimation errors and prediction errors are also considered. This leads to very general bounds on prediction error, which can be specialized to specific cases (e.g. perfect measurement will mean ξx→0). Also worthy of note is the fact that we have not considered the model mismatch to be state-dependent, as it does not have obvious practical application in mobile robotics. In fact, if the system is very nonlinear, one cannot expect modeling error to reduce with state, as in many cases larger state amplitude offers better model fidelity. Moreover, the FHOCP is recursively feasible.

Satisfying constraints along the horizon depends on the future realization of the uncertainties, which are random. By assuming Lipschitz continuity of the nominal disturbance and state models it is possible to compute bounds on effect of the evolving uncertainties on the system. Since, our system consists of many possible sources of uncertainty, the bound calculated will be much more involved and comprehensive than those presented in existing literature.

With respect to the convex optimal control problem (OCP (A)) for maximizing a terminal constraint set, the volume of terminal constraint set X_{f}(a)={\tilde{x}: \tilde{x}^{T} Q_{f} \tilde{x}≦a}, for a>0, within set M defined in (4.13) with cost functional (3.58), is maximized for matrix variables

$${W}_{1} {=}^{Δ} {Q}_{f}^{- 1} ∈ and {W}_{2} {=}^{Δ} {KQ}_{f}^{- 1} ∈$$

by solving:

$$\begin{matrix}{min}_{{W}_{1} , {W}_{2} , a} log {det ( a {W}_{1} )}^{- 1} , & ( 23 ) \\ {W}_{1} = {W}_{1}^{T} > 0 , & ( 24 ) \\ a > 0 , & ( 25 ) \\ [ \begin{matrix}{W}_{1} & {( {A}_{v} {W}_{1} + {B}_{v} {W}_{2} )}^{T} & {{W}_{1} ( Q - \tilde{S} )}^{1 / 2} & {W}_{2}^{T} {R}^{1 / 2} \\ * & {W}_{1} & 0 & 0 \\ * & * & I & 0 \\ * & * & * & I\end{matrix} ] \geq 0 , \\ for v = 1 , … , \overline{v} . & ( 26 ) \\ [ \begin{matrix}1 \text{/} a & {( {\overline{c}}_{v} {W}_{1} + {\overline{d}}_{v} {W}_{2} )}^{T} \\ * & {W}_{1}\end{matrix} ] \geq 0. & ( 27 )\end{matrix}$$

Matrix \tilde{S} is a positive definite matrix. Additionally, if it is required to converge with a given rate â then the OCP is subject to another condition:

$$[ \begin{matrix}- ( Q - ( \tilde{S} + \hat{α} {I}_{n} ) ) & {W}_{2}^{T} \\ * & {R}^{- 1}\end{matrix} ] \geq 0. \qquad ( 28 )$$

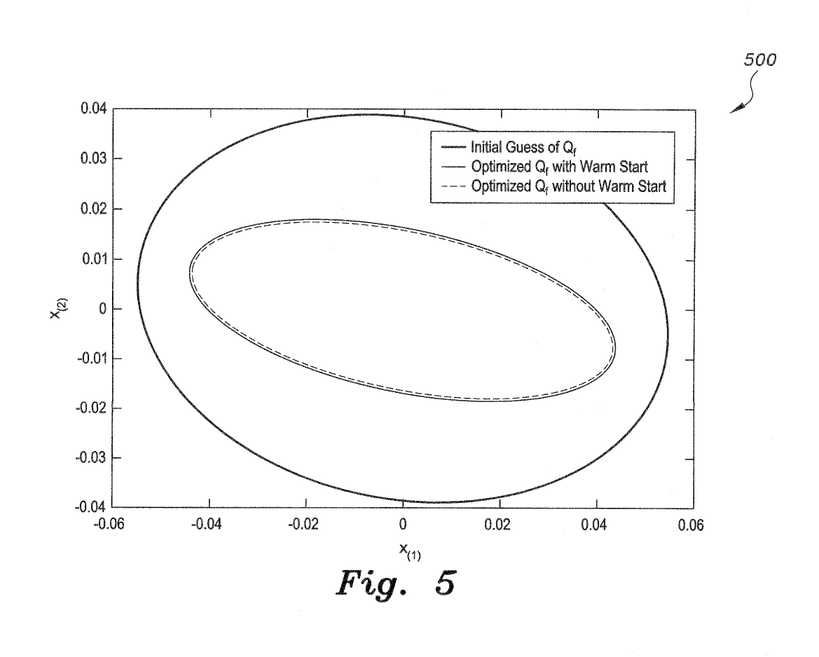

Plots 500 of FIG. 5 indicate comparative optimized terminal regions with and without the use of the warm start procedure of Algorithm 4 by Algorithm 3. The optimized terminal set and terminal control determination procedure is summarized in Table 3.

TABLE 3
Algorithm 3 Optimizing Terminal Region and Control

| | |
|---|---|
| 1: | Given nominal models \tilde{f}~(\tilde{x},u,0)), and cost weights Q, R and S. |
| 2: | Select \tilde{S} ε [symbol] ^{n×n}, such that −q(\tilde{x},\tilde{w}) + ψ(\tilde{w}) ≦ \tilde{x}_{c}ⁱ\tilde{S}\tilde{x} |
| 3: | Get initial guess values of Q_{f} as Q_{f}^{∞} and K as K^{∞} by Algorithm 4 |
| 4: | procedure CONVEX OPTIMIZATION |
| 5: | Solve convex OCP (A) using parameterized state and control |
| | constraints (3) subject to (24)-(27). |
| 6: | if X_{f} ⊂ \tilde{X}_{t+N}_{ₚ} then |
| 7: | Go to 11 |
| 8: | else |
| 9: | Solve convex OCP (A) subject to (24)-(28). |
| 10: | end if |
| 11: | end procedure End algorithm; accept optimal values of Q_{f}, |
| | K and a. |

Most modern software packages select the initial iterate internally. For example, the SDPT3 semidefinite programming package algorithms can start with an infeasible starting point, as the algorithms try to achieve feasibility and optimality of its iterates simultaneously.

However, the performance of these algorithms is quite sensitive to the choice of the initial iterate. Reasonable initial guesses are often crucial, especially in non-convex optimization. It is advisable to choose an initial iterate that at least has the same order of magnitude as the optimal solution. Therefore the present invention provides an initial guess of optimization variables to warm-start Algorithm 3 by solving discrete-time algebraic Riccati equations (DARE) at each vertex point as follows:

Q_{f}_{ᵥ}^{∞}=(Q−\tilde{S})+Aᵥ^{T} (Q_{f}_{ᵥ}^{∞}+Q_{f}_{ᵥ}^{∞}Bᵥ(R+Bᵥ^{T}Q_{f}_{ᵥ}^{∞}Bᵥ)⁻¹Bᵥ^{T}Q_{f}_{ᵥ}^{∞})Aᵥ, (29)

where Q_{f}_{ᵥ}^{∞}is the solution to the DARE above. The control gain computed from eqn. (29) is given as:

Kᵥ^{∞}=(R+Bᵥ^{T}Q_{f}_{ᵥ}^{∞}Bᵥ)⁻¹Bᵥ^{T}Q_{f}_{ᵥ}^{∞}Aᵥ. (30)

It should be understood that v̅ takes on values of Kᵥ^{∞} and Q_{f}_{ᵥ}^{∞}. Therefore, we will solve another optimization problem that finds the maximum volume ellipsoid which is confined in the intersection of all the \tilde{v} vertex ellipsoids. This will serve as the initial guess for W₁⁰=Q_{f}_{ᵥ}^{∞}. It is important to note that the initial guess is based on solution of unconstrained algebraic Riccati equations (29). Therefore, we formulate the following convex OCP by exploiting the S-procedure. Thus, warm-start for Algorithm 3 assumes v̅ vertex ellipsoids

$${ɛ}_{v}^{n} ( {Q}_{fv}^{∞} ) {=}^{Δ} \{ \tilde{x} ∈ {ℝ}^{n} \text{:} {\tilde{x}}^{T} {Q}_{fv}^{∞} \tilde{x} \leq 1 \}$$

which are solutions of Riccati equations (29), the maximum volume ellipsoid in the intersection of all εᵥⁿis obtained by solving the following convex OCP (2) for some Lagrangian variables tᵥ:

$$\begin{matrix}{min}_{{\tilde{W}}_{∞}} - log det {\tilde{W}}^{∞} , subject to & ( 31 ) \\ {\tilde{W}}^{∞} > 0 & ( 32 ) \\ 1 \geq {t}_{v} \geq 0 & ( 33 ) \\ {t}_{v} {\tilde{W}}_{v}^{∞} - {\tilde{W}}^{∞} \geq 0 for v , … , \overline{v} . \\ Here {\tilde{W}}^{∞} {=}^{Δ} {( {Q}_{f}^{∞} )}^{- 1} and {\tilde{W}}_{v}^{∞} {=}^{Δ} {( {Q}_{fv}^{∞} )}^{- 1} . & ( 34 )\end{matrix}$$

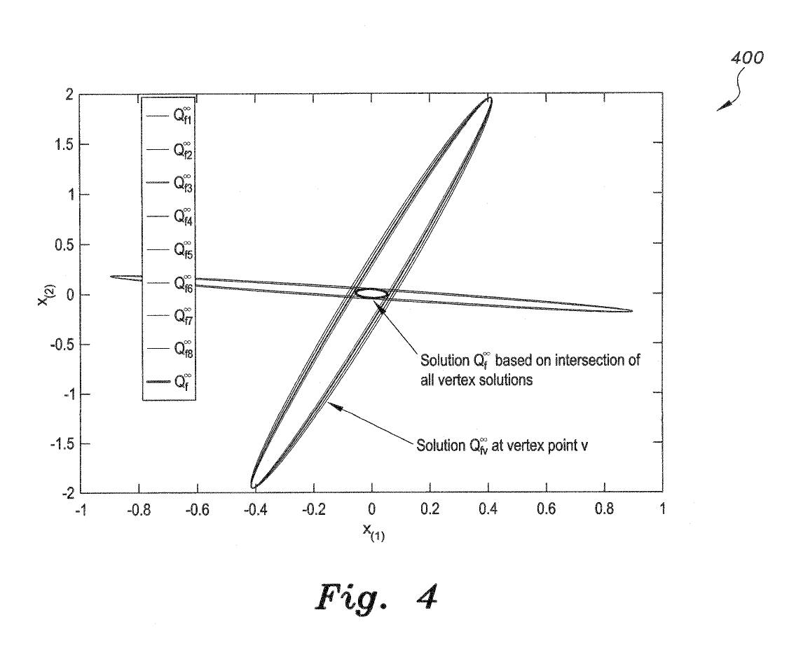

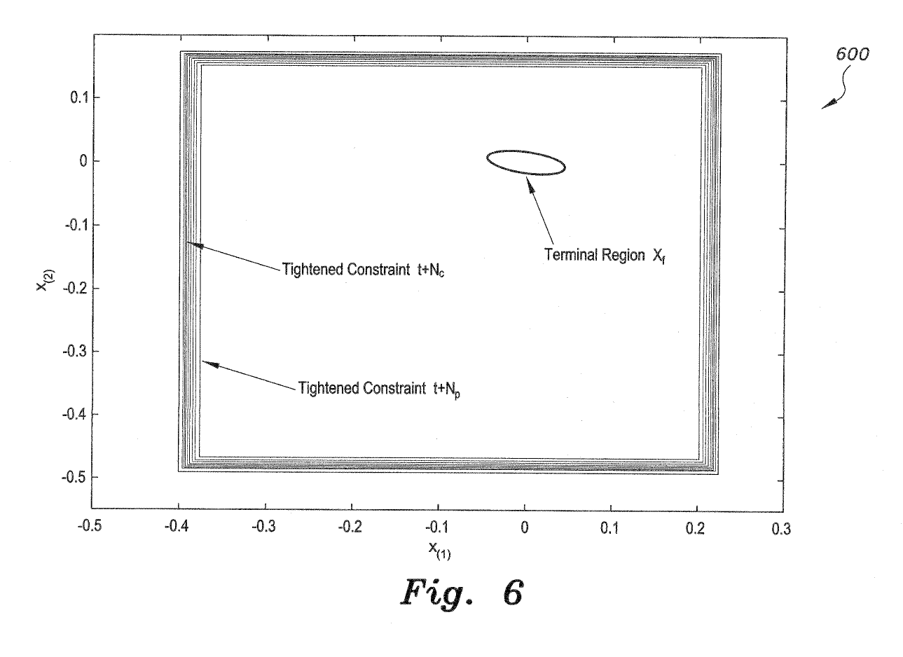

FIG. 4 illustrates the warm start ellipsoids 400 used in Algorithm 4 as applied to an exemplary case. Plot 600 of FIG. 6 illustrates terminal region X_{f} optimized with Algorithms 3 and 4 for an exemplary case. Tightened constraints from Algorithm 2 are also shown. The warm-start procedure is summarized in Table 4.

TABLE 4
Algorithm 4 Warm-Start Procedure for Algorithm 3

| | |
|---|---|
| 1: | procedure CONVEX OPTIMIZATION |
| 2: | Solve Riccati equations (29) for vertex values of Q_{fv}^{∞} |
| 3: | Solve convex OCP (2) to obtain Q_{f}^{∞} |
| 4: | Calculate K^{∞} by solving (30) for Q_{f}^{∞} at A₀ andB₀, i.e. |
| | linearization of origin |
| 5: | end procedure End algorithm and pass Q_{f}^{∞} and K^{∞} to Algorithm 3 |

Regarding Determination of 1-Step Controllable Set to Terminal Constraint Set, the maximum allowable uncertainty is bounded by the minimum size of the 1-step controllable set to X_{f}, denoted by C₁(X_{f}). In particular, this bound on uncertainty was shown to ensure recursive feasibility. Therefore, it is imperative to determine the minimum size of C₁(X_{f}), i.e., the minimum size of 1-step controllability set to terminal set X_{f}is defined as:

$$\overline{d} {=}^{Δ} dist ( {\tilde{X}}_{t + {N}_{c} ,} \backslash {C}_{1} ( {X}_{f} , {\tilde{X}}_{t + {N}_{c} ,} ) , {X}_{f} ) . \qquad ( 35 )$$

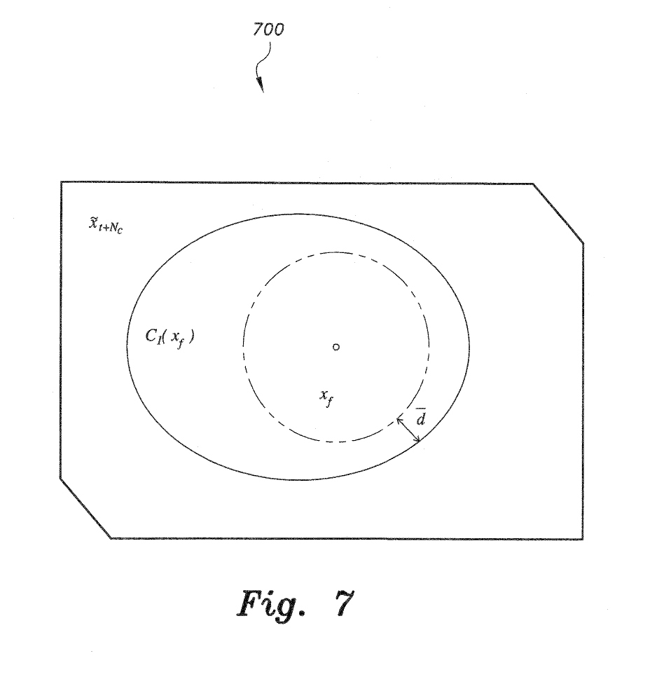

The relationship 700 between \tilde{X}_{t+N}_{_{c}}_{,} C₁ (X_{f})and d̅ is illustrated in FIG. 7. It is clear that to find d̅, we must know the topology of C₁(X_{f}). There are various techniques for estimating one-step controllability to given sets. The present method contemplates an explicit method based on min-max optimization to give better estimates of C₁(X_{f}). Let the boundary of X_{f}and C₁(X_{f}) be denoted by ∂(X_{f}) and \tilde{x}_{C}_{₁}ⁱ ∈ ∂ (C₁(X_{f})), respectively. The One Step Controllable Set to X_{f} Determination procedure summarized in Table 5 is presented for this purpose.

TABLE 5
Algorithm 5 Determining One Step Controllable Set to X_{f}

| | |
|---|---|
| 1: | Divide the boundary of terminal set ∂(X_{f}) into Ñ steps. |
| 2: | Solve OCP (3) to find points \tilde{x}_{c}ⁱ ε ∂(C₁(X_{f}))for i = 1, . . . , N̅. |
| 3: | Calculate minimum size of C₁(X_{f}) as d̅ = min(\|\tilde{x}_{c}_{₁}¹ − \tilde{x}_{f}¹\|, . . . , |
| | \|\tilde{x}_{C}_{₁}^̅{̅N̅}̅ − \tilde{x}_{f}^̅{̅N̅}̅\|) for \tilde{x}_{f}ⁱ ε ∂(X_{f}) and i = 1, . . . , N̅ |

OCP (3), Min-Max Optimization of One-Step Robust Controllability Set is as follows. Given the target set X_{f}, tightened constraints defined in (19)-(20) and nominal constraints (3), let the boundary of X_{f} be discretized appropriately into N̅ point x̅_{f}ⁱ ∈ ∂(X_{f}) for i=1, . . . , N̅. Then, the one-step robust controllability set C₁(X_{f}) is obtained by solving the following N̅ min-max OCPs:

$${\tilde{x}}_{{c}_{i}}^{i} = {max}_{\tilde{w}} ( {min}_{u} ( - log ( {\tilde{x}}_{{C}_{1}}^{i} {Q}_{f}^{∞} ) ) ) , \qquad ( 36 )$$

for i=1, . . . , N̅, subject to:

\tilde{x}_{f}ⁱ=\tilde{f}(\tilde{x}_{c}_{₁}ⁱ, u, \tilde{w}) (37)

1−\tilde{x}_{c1}ⁱQ_{f}^{∞}\tilde{x}_{c}_{₁}ⁱ≦0 (38)

\tilde{x}_{c1}ⁱ ∈ \tilde{X}_{N}_{_{c}}₋₁, u ∈ U, \tilde{w} ∈ \tilde{W}_{N}_{_{c}}₋₁, (39)

The boundary of C₁(X_{f}) is given as ∂ (C₁(X_{f}))={\tilde{x}_{c1}¹, ∀i=1, . . . , N̅}. Notice that even though cost functional (36) is convex, the overall OCP is not convex due to presence of nonlinear constraints (37) and (38). Due to non-convexity, it is important to have a good initial guess. This can be easily accomplished by choosing initial guess in the sector of state space where the half space containing x_{f}ⁱ lies. Cost functional (36) is the convex form of (\tilde{x}_{c1}Q_{f}\tilde{x}_{c}_{₁}ⁱ)⁻¹, minimizing which maximizes the distance from X_{f}={\tilde{x}:\tilde{x}Q_{f}\tilde{x}≦1}. Constraint (37) ensures that \tilde{x}_{c1}ⁱ is the point from which the point \tilde{x}_{f}ⁱ ∈ ∂(X_{f}) can be reached in exactly one step. Constraint (38) ensures that is outside X_{f}. Finally the cost is minimized with control u, but maximized with respect to the disturbance \tilde{w} to account for the worst case of disturbance input.

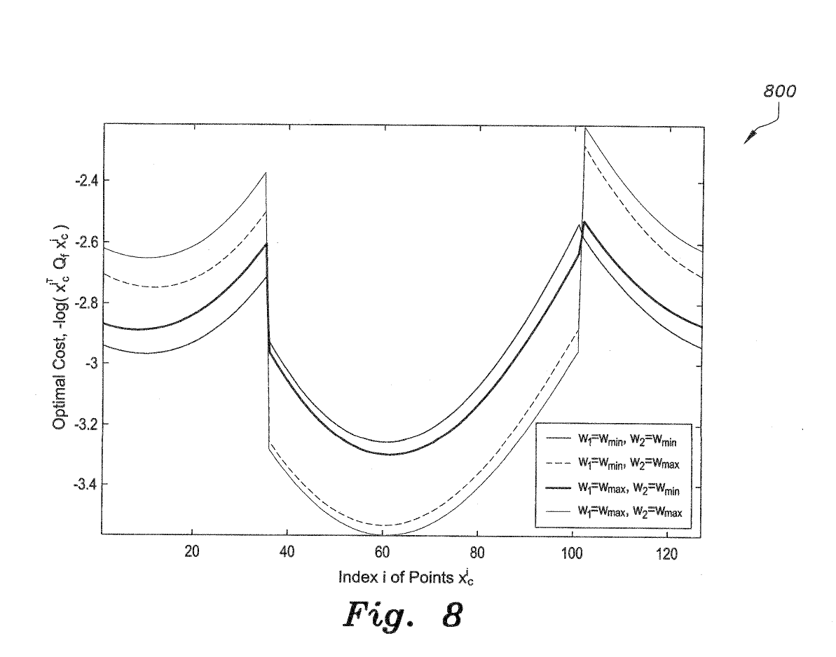

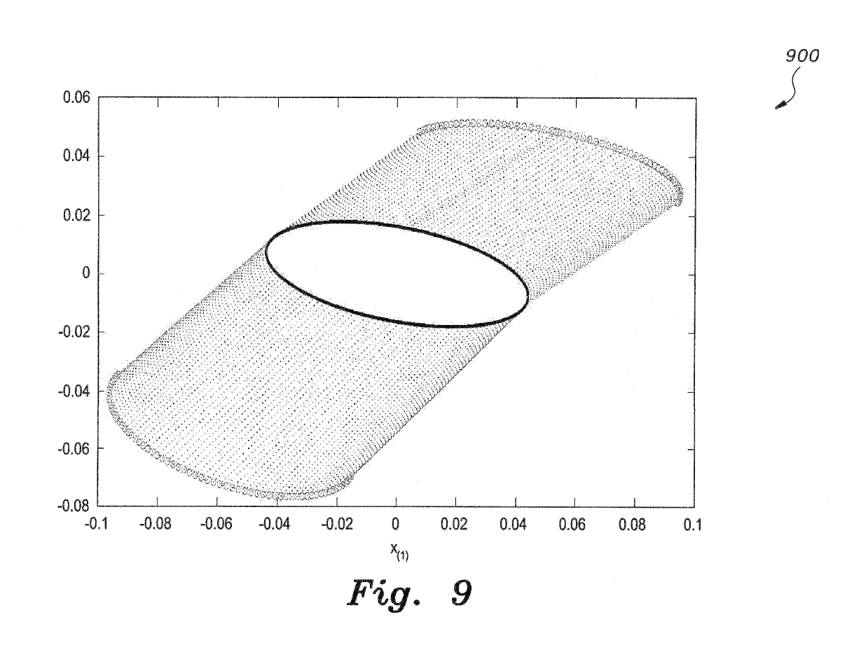

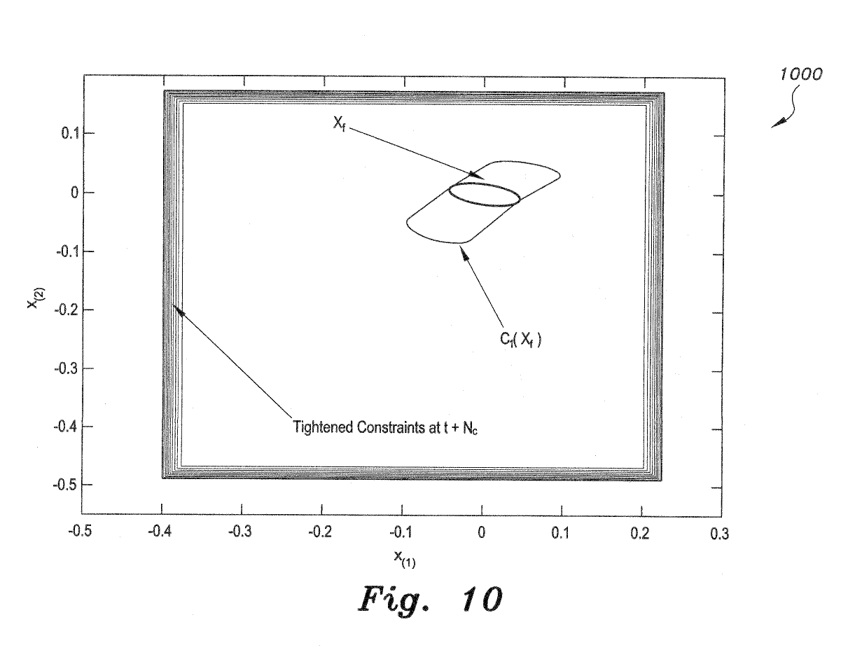

Plot 800 of FIG. 8 shows an optimal cost graph of a nonlinear oscillator with various disturbance levels using Algorithm 5. Algorithm 5 may be applied to determine the one-step robust controllability set to terminal set X_{f}. Plot 900 of FIG. 9 shows the boundary points of one step controllability set calculated using algorithm 5 in an exemplary case. Plot 1000 of FIG. 10 shows one-step controllability set calculated using algorithm 5 for the exemplary case.

Algorithm 6 extends algorithm 5 to solve for the entire feasibility region of for the MPC algorithm. Robust one-step controllability set C₁(X_{f}) contains the target set X_{f}, i.e. X_{f} ⊂ C(X_{f}). Robust one-step controllability set C(X_{f}) to the terminal set X_{f}, is contained in the one-step controllability set of robust output feasible set X_{MPC}, i.e.:

C₁(X_{f})⊂ C₁(X̅_{mpc}) (40)

Robust one-step controllability set C(X_{f}) to the terminal set X_{f} can be written as a finite union of polyhedra. The one-step controllable set operator can be used recursively to define l-step controllable set C₁(X_{f}) as follows (for l≧2):

Cₗ(X_{f})=C₁(Cₗ₋₁(X_{f})). (41)

The boundary of target set, i.e. ∂(X_{f}) is included in the one step controllable set C₁ (X_{f}):

∂(X_{f}) ⊂ C₁(x_{f}). (42)

Given the terminal set X_{f}, tightened constraints \tilde{x} ∈ \tilde{X}ₜ₊₁, \tilde{w} ∈ \tilde{W}ₜ₋₁, for l=1, . . . , N_{c} and control constraint u ∈ U, the robust feasibility set is obtained by N_{c}applications of the one-step controllable set operator C_{∞}(·) by recursively solving OCP (3), such that:

$${X}_{MPC} = {{⋃}_{l = 2}}^{l = {N}_{c}} {C}_{1} ( {C}_{l - 1} ( {X}_{f} ) ) ⋃ {C}_{1} ( {X}_{f} ) ⋃ {X}_{f} \qquad ( 43 )$$

which can be generalized as follows:

$${X}_{MPC} = {C}_{l} ( {C}_{{N}_{c} - 1} ( {X}_{f} ) ) = {C}_{1} ( {C}_{1} ( {C}_{{N}_{c} - 2} ( {X}_{f} ) ) ) … = {C}_{1} ( {C}_{1} ( … {C}_{1} ( {X}_{f} ) ) ) . \qquad ( 44 )$$

Thus, the recursive X_{MPC} Feasibility Region determination procedure is summarized in Table 6.

TABLE 6
Algorithm 6 Determining Feasibility Region X_{MPC}

| | |
|---|---|
| 1: | Determine C₁(X_{f}) by using Algorithm 5, given as \tilde{x}_{C}_{₁}ⁱ ε ∂(C₁(X_{f}) |
| | for i = 1, . . . , N̅. |
| 2: | procedure RECURSIVE ESTIMATION OF X_{MPC} |
| 3: | for l = 2, . . . , N_{C} do |
| 4: | if l = 2 then |
| 5: | Solve OCP (3) with target set C₁(X_{f}) to obtain C₂(X_{f}) = |
| | C₁(C₁(X_{f})) |
| 6: | else |
| 7: | Solve OCP (3) with target set Cₗ₋₁(X_{f}) to obtain Cₗ(X_{f}) = |
| | C₁(Cₗ₋₁(X_{f})) |
| 8: | end if |
| 9: | end for |
| 10: | Determine X_{MPC} according to (43). |
| 11: | end procedure |

The method given in Algorithms 5-6 is computationally demanding. However, all algorithms in this chapter are for used offline in the proposed MPC scheme, therefore computational burden is not an overriding concern. However, we must provide the caveat that choosing initial conditions for higher dimension systems is far less intuitive. In that case Algorithms 5-6 should be implemented in a heuristic (non-gradient-based approaches) to avoid the problems of local minima.

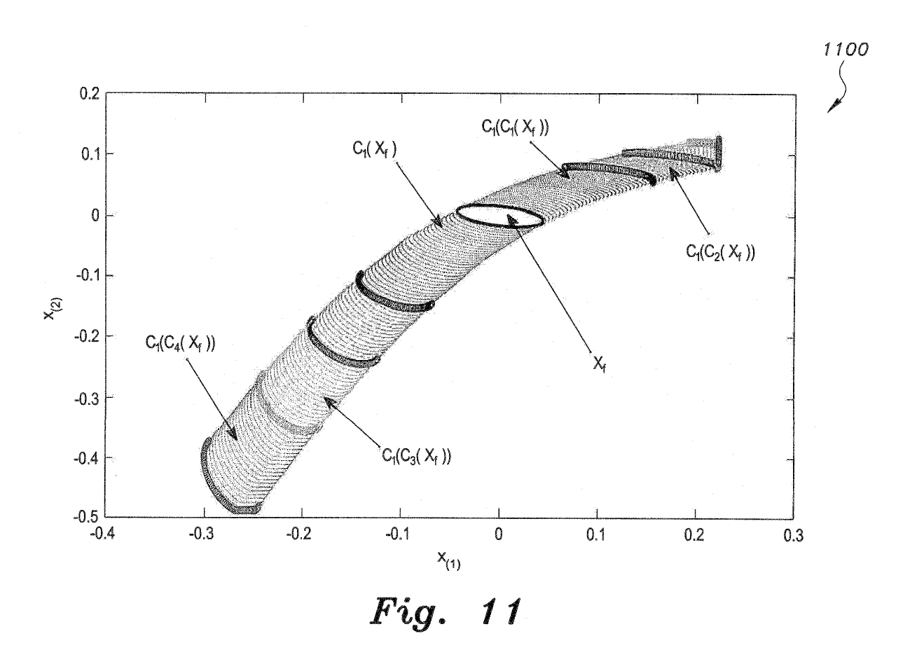

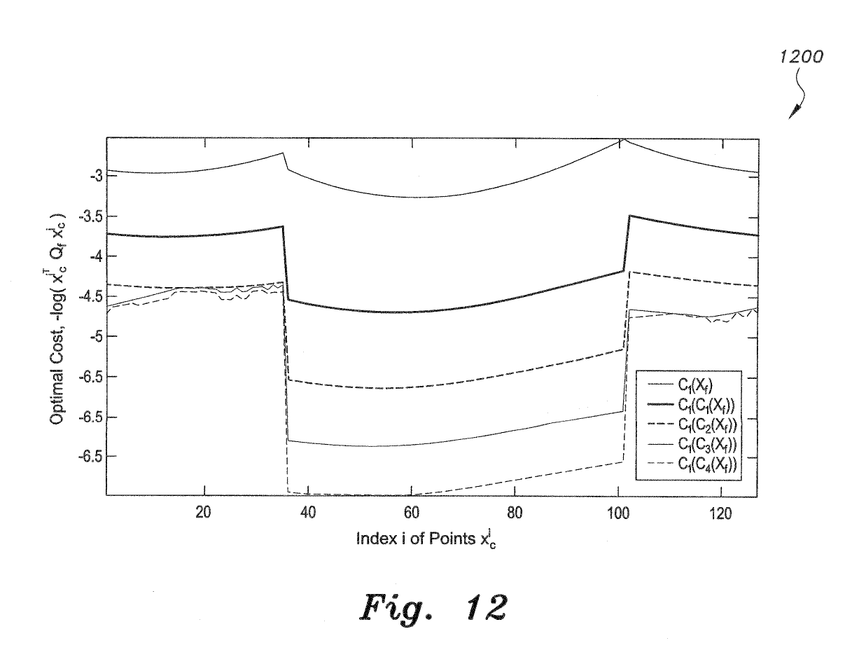

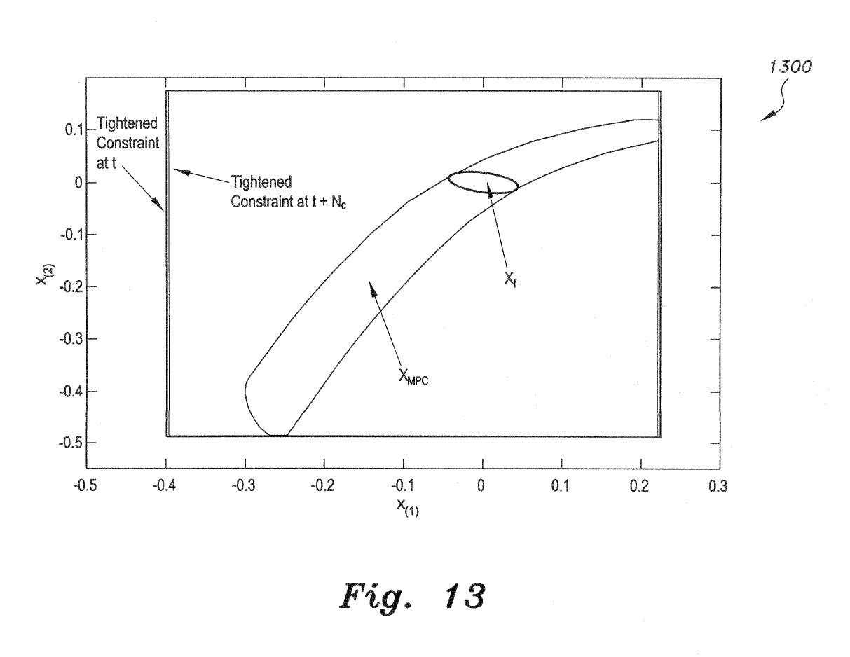

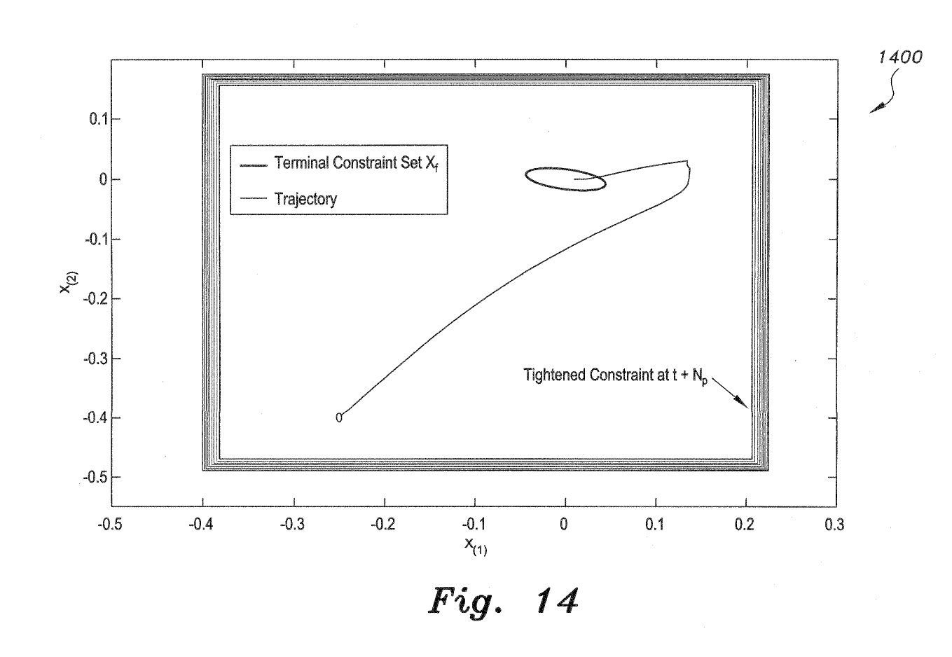

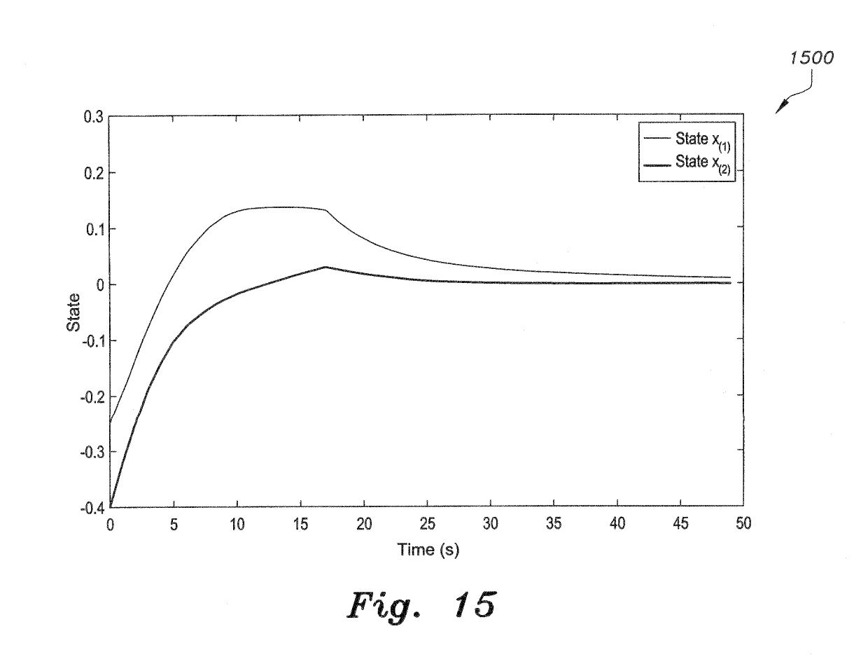

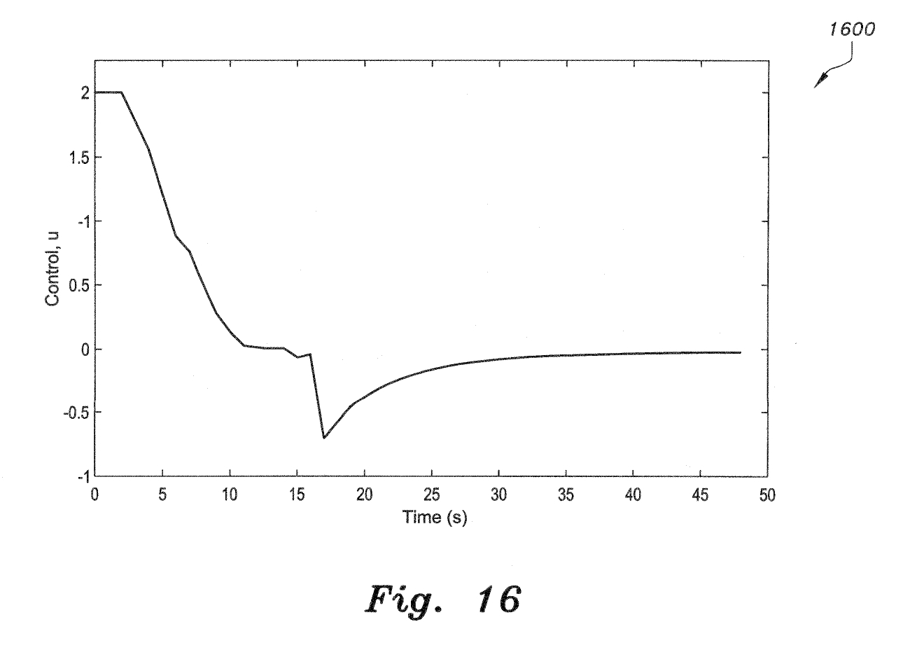

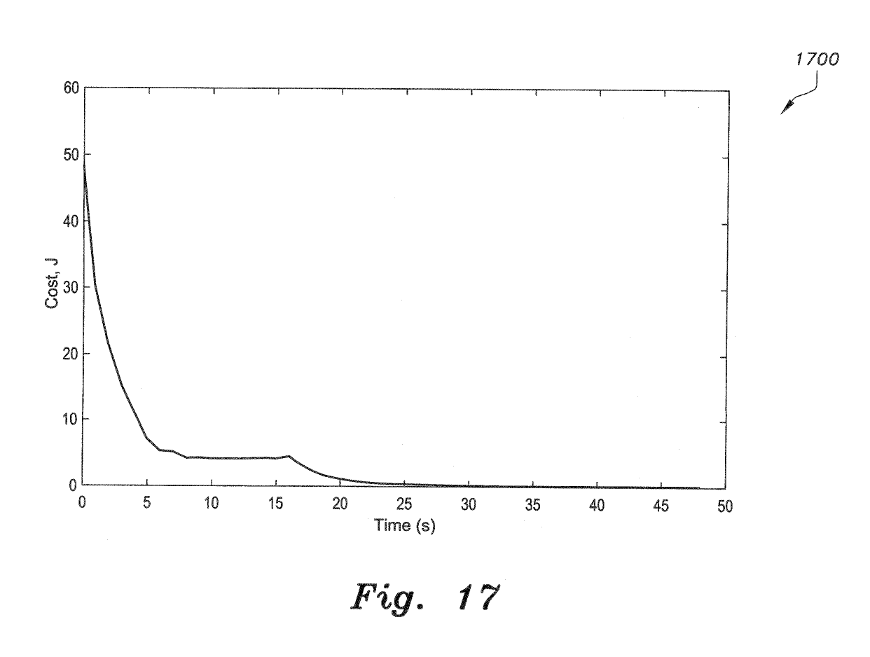

Plot 1100 of FIG. 11 illustrates an example of recursive one-step controllable sets. Circles indicate set boundary points and dotted lines show one step trajectories between boundaries of successive sets. Plot 1200 of FIG. 12 illustrates optimal cost for boundary points of 1-step controllable sets using algorithm 6 for the exemplary nonlinear oscillator case. Plot 1300 of FIG. 13 illustrates Robust Output Feasible Set X_{MPC} with Tightened Constraints. Boundaries of X_{MPC} coincide with tightened constraint \tilde{X}_{t+N}_{_{c}}, the online part of Algorithm 1, implemented using fmincon package of Matlab. The goal is to regulate the state to the origin, without violating any constraints. It can be observed that the state does not converge to zero, since only practical stability is guaranteed. Plot 1400 of FIG. 14 shows the state trajectory in the phase plane, along with terminal region X_{f} and tightened constraints. Evolution of the states with time is shown in plot 1500 of FIG. 15, where it is again clear that the state does not converge to the origin due to the presence of uncertainty. The control input calculated by application of Algorithm 1 is shown in plot 1600 of FIG. 16. The figure shows how the maximum control authority is utilized initially without violation of this constraint, which is a unique feature of NMPC. Plot 1700 of FIG. 17 shows the evolution of the exemplary cost functional (3.58), which decreases monotonously, as expected. Computation time for offline part of Algorithm 1 was 320 seconds and for 50 seconds of simulation, the online algorithm took 39 seconds of computation time, on an Intel Core i5-4210U 2.7 GHz machine with 4 GB memory. This is adequate for online implementation, and can be further improved with dedicated code and hardware.

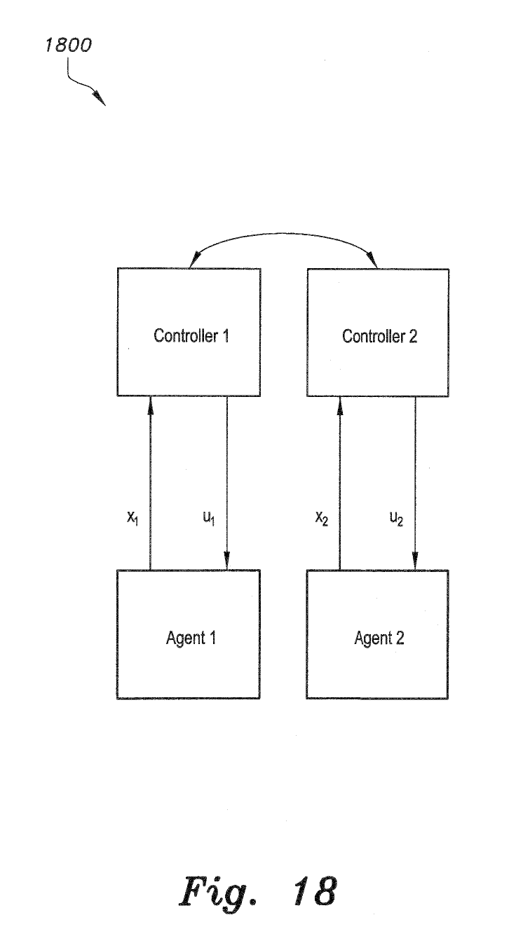

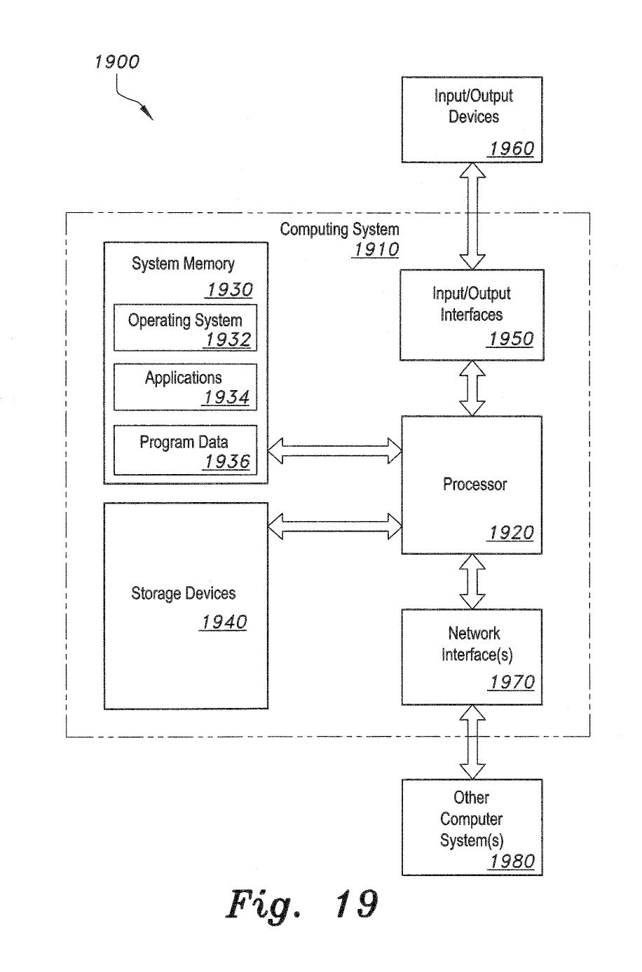

This method contemplates the distributed control of a fleet of autonomous agents. Often the main task in multi-vehicle cooperative control is formation. Formations control means the ability to move the entire fleet with a common speed and heading. This invariably means that the vehicles in the team should be able to either sense the states of team members, or receive state information from other team members. In most cases however, the communication occurs wirelessly as the agents are spread over a large area or it is not possible to maintain tethered connection network due to movement of vehicles and presence of obstacles. Also due to mobile nature of these vehicles, the on-board computational power is limited due to size and power budgets. Therefore, distributed control, 1800 as shown in FIG. 18, is often the only practical control architecture. Computer block 1900 (shown in FIG. 19) is an exemplary means for performing distributed control 1800 and may have a computing system 1910 comprised of I/O devices 1960 connected to I/O interfaces 1950, and which are, in turn, connected to processor 1920, which is connected to network interfaces 1970, program data 1936, applications 1934, operating system 1932 and system memory 1930. The processor may be connected to storage devices 1940. Additional interface may be used to connect to other computer systems 1980.

There are three basic elements in multi-agent formation control; Cohesion: attraction to distant neighbors up to a reachable distance. Alignment: velocity and average heading agreement with neighbors. Separation: repulsion from neighbors within some minimal distance. This is also called collision avoidance. Formation control without collision avoidance is also called state synchronization.

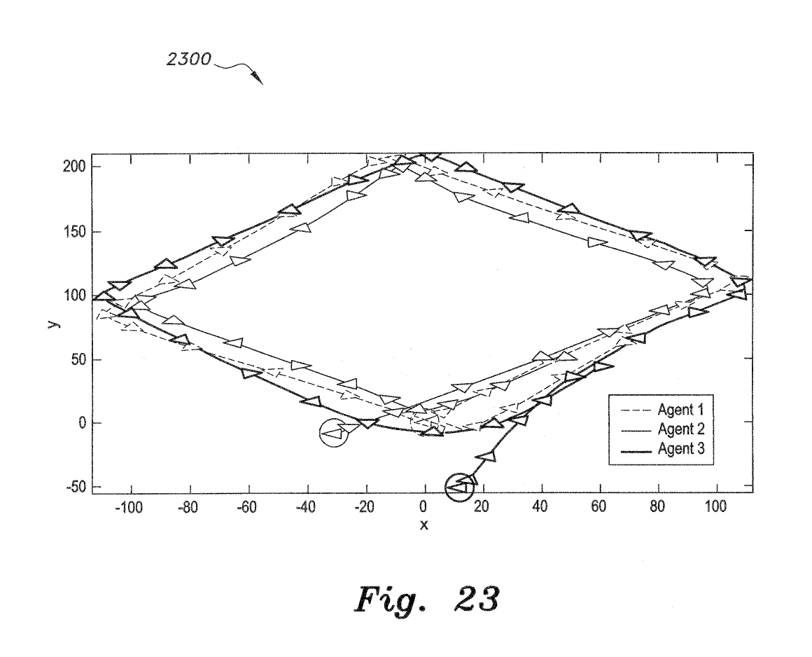

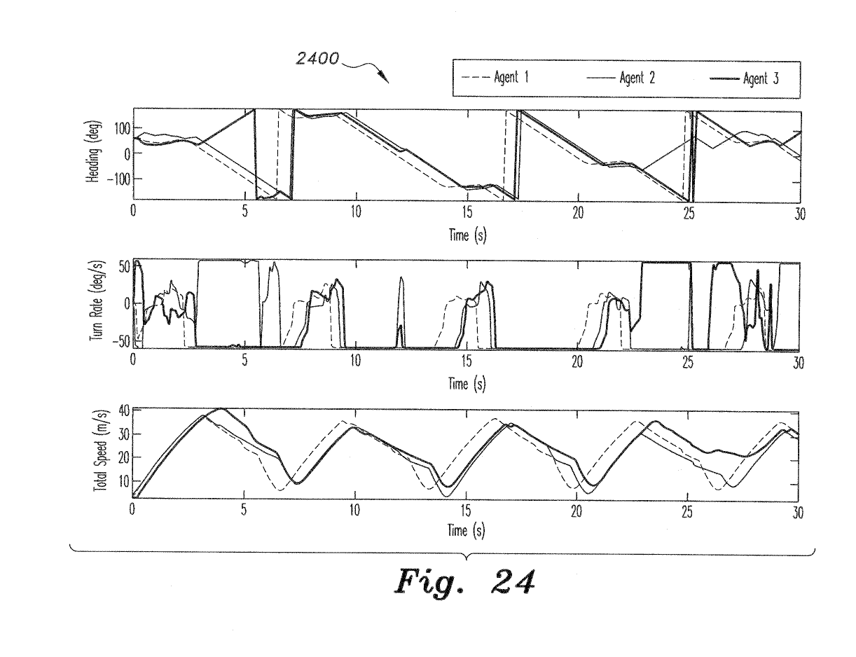

In a dynamic neural network based adaptive control scheme for distributed fleet state synchronization, without the need to know local or leader (nonlinear) dynamics. Lyapunov analysis is used to derive tuning rules, with the implicit need for persistent excitation, for both strongly connected and weakly (simply) connected networks. Plot 2300 of FIG. 23 illustrates three agents in a strongly connected network. Plots 2400 of FIG. 24 illustrates the states of the three agents in the strongly connected network. However, delays, asynchronous measurements, collision avoidance and limits on control actuation forces are not considered. In a similar approach, synchronization of nonlinear Lagrangian systems with linear-in-parameter model uncertainties has been solved using distributed adaptive back-stepping and adaptive redesign all agents are assumed to have access to group reference trajectory, which constitutes a further limitation. Synchronization of a fleet of nonlinear Euler-Lagrangian systems has also been achieved using distributed H_{∞} controllers robust to model uncertainties and disturbances in fixed and switching network topologies guaranteeing input to state stability (ISS).

We address the problem of leader-follower formation control of constrained autonomous vehicles subject to propagation delays. We consider the simultaneous presence of six sources of uncertainty: (i) error in estimating current state; (ii) error in estimating current external input (disturbance or external information); (iii) error in predicting future system state due to model mismatch; (iv) error in predicting future external input due to disturbance model mismatch (disturbance model is another uncertain dynamic system with unknown in-put); (v) error in approximating trajectory due to data compression; and (vi) error in approximating the last segments (tail) of the compressed trajectory due to propagation delays.

Limited network throughput demands reduction in packet size. The proposed approach achieves formation tracking through NMPC such that each agent performs local optimization based on planned approximate trajectories received from its neighbors. Since exchanging the entire horizon will increase packet size proportional to length of prediction horizon, the trajectory is compressed using neural networks, which is shown to reduce the packet size considerably. Moreover, the method allows the agents to be heterogeneous, make asynchronous measurements and have different local optimization parameters. Correction for propagation delays is achieved by time-stamping each communication packet. Collision avoidance is achieved by formulating a novel spatial-filtered potential field, which is activated in a “zone of safety” around the agent's trajectory. New theoretical results are presented along with validating simulations.

OCP (4): Consider a set of N agents, where each agent is denoted as Aⁱ with i=1, . . . , N. Each agent has the following open loop nonlinear discrete-time dynamics described by

xₜ₊₁ⁱ=f₀ⁱ(xₜⁱ, uₜⁱ), ∀i≧0,i=1, . . . , N (45)

where f₀ⁱ is a nonlinear map for local open loop dynamics, xₜⁱ, uₜⁱ are states and controls local to agent Aᵢ. These variables belong to the following constraint sets:

$${x}_{t}^{i} ∈ {X}^{i} ⋐ {R}^{{n}^{i}} , {X}^{i} {=}^{△} \{ {x}^{i} : {x}_{min} \leq {x}^{i} \leq {x}_{max}^{i} > 0 \} \\ {u}_{t} ∈ {U}^{i} ⋐ {R}^{{m}^{i}} , {U}^{i} {=}^{△} \{ {u}^{i} : {u}_{min} \leq {u}^{i} \leq {u}_{max}^{i} > 0 \} . \qquad ( 46 )$$

One can observe that the agents' dynamics (1) are decoupled from each other in open loop. This is the standard case for most formation control problems. Focusing on team of dynamically decoupled agents and due to measurements corrupted with sensor noise, we assume that local states are estimated (locally) with bounded error ξxi, such that:

\tilde{x}ₜⁱ=xₜⁱ+ξₓ_{ₜ}ⁱ, ξₓⁱ≦|ξₓ_{ₜ}ⁱ≦ξ̅ₓⁱ|. (47)

Even though the agents are dynamically decoupled, they need to cooperate with each other to perform the formation keeping task. To achieve this goal, a co-operation component is added to the cost functional (performance index) of each agent. To this end, define wₜⁱ as an information vector transmitted to agent Aᵢ by other agents in its neighborhood Gᵢ, which consists of the states of these neighbors.

The external input to agent Aᵢ in formation control task in a multi-agent system consists of state information of other agents in its neighborhood Gi, such that:

$${w}^{i} {=}^{△} col ( {x}^{j} ) ∀ j = 1 , … , {M}^{i} , j ∈ {G}^{i} , j \neq i , \qquad ( 48 )$$

where Mⁱis the number of agents in the neighborhood of Aᵢ. This external input in the form of the information vector wⁱ is driven by the dynamics of the neighboring systems, as below:

$${w}^{i} {=}^{Δ} col ( {x}^{j} ) ∀ j = 1 , … , {M}^{i} , j ∈ {G}^{i} , j \neq i , \qquad ( 49 )$$

where gⁱ is a nonlinear map composed of nonlinear dynamics of neighboring agents and their local inputs

$${φ}_{t}^{i} {=}^{Δ} col ( {u}_{t}^{j} ) .$$

We assume that the information vector is constrained to the following set:

$${w}_{t}^{i} ∈ {W}^{i} ⋐ {ℝ}^{{p}^{i}} , {W}^{i} {=}^{Δ} \{ {w}^{i} \text{∷} {w}_{min}^{i} \leq {w}^{i} \leq {w}_{max}^{i} > 0 \} . \qquad ( 50 )$$

Moreover, assume that we have an updatable approximation for wⁱ, which produces the approximation \tilde{w}ⁱ, such that:

\tilde{w}ₜⁱ=wₜu+ξ_{w}_{ₜ}ⁱ, ξ_{w}ⁱ≦|ξ_{w}_{ₜ}ⁱ≦ξ̅_{w}ⁱ|. (51)

We assume that we do not have exact knowledge of the evolution of the information over the horizon i.e. w_{t,t+N}_{ₚ}ⁱ, and that we can only have an approximation of it \tilde{w}_{t,t+N}_{ₚ}ⁱ. Also, let us assume that the agent Aᵢ has nominal model \tilde{g} (·) of the true information vector (49) given by:

\tilde{w}ₜ₊₁^{o}=\tilde{g}^{i l (}\tilde{w}ₜⁱ), (52)

such that there is a bounded information vector transition uncertainty due to information vector model mismatch:

\tilde{g}(wₜⁱ)=g(wₜⁱ, φₜⁱ)+e_{w}_{ₜ}ⁱ, e_{w}ⁱ≦|e_{w}_{ₜ}ⁱ|≦ē_{w}ⁱ (53)

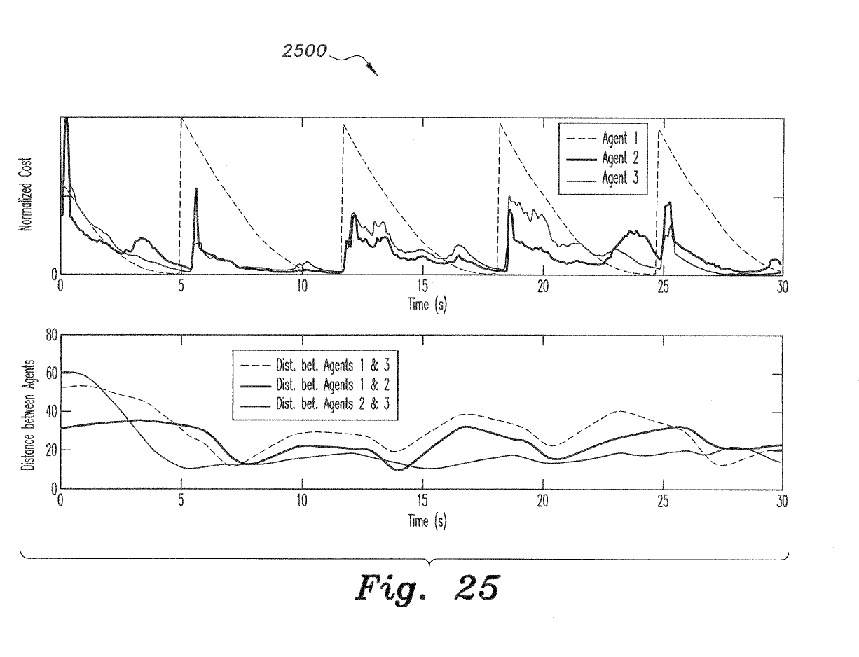

Now, let the distributed cost function of each agent be given as:

$${J}_{t}^{i} ( {\tilde{x}}^{i} , {u}^{i} , {\tilde{w}}^{i} , {d}^{{h}^{i}} , {d}^{{q}^{i}} {N}_{c}^{i} , {N}_{p}^{i} ) = {\sum }_{l = t}^{t + {N}_{c}^{i} - 1} [ {h}^{i} ( {\tilde{x}}_{l}^{i} , {u}_{l}^{i} , {d}^{{h}^{i}} ) + {q}^{i} ( {\tilde{x}}_{l}^{i} , {\tilde{w}}_{l}^{i} , {d}^{{q}^{i}} ) ] + {\sum }_{l = t}^{t + {N}_{p - 1}^{i}} [ {h}^{i} ( {\tilde{x}}_{l}^{i} , {k}_{f}^{i} ( {\tilde{x}}_{l}^{i} ) , {d}^{{h}^{i}} ) + {q}^{i} ( {\tilde{x}}_{l}^{i} , {\tilde{w}}_{l}^{i} , {d}^{{q}^{i}} ) ] + {h}_{f}^{i} ( {\tilde{x}}_{t + {N}_{p}^{i}}^{i} , {d}^{{h}^{i}} ) , \qquad ( 54 )$$

where Nₚ^{o}and N_{c}ⁱ are prediction and control horizons, respectively according to the NMPC notation. The distributed cost function (54) consists of: (i) Local transition costhⁱ, which is the cost to reach a local target state, which is embedded in the local alignment vector d^{t}^{ⁱ}; (ii) cooperative cost qⁱ, which is the cost for agent Aⁱ to converge to an aligned state with its neighbors A^{j} ∈ Gⁱ, where the cooperation goal is embedded in the cooperative alignment vector d^{q}^{ⁱ}; and (iii) terminal cost h_{f}ⁱ is the cost of distance between the local state at t+Nₚⁱ and the local target state. Local control sequence u_{t,t+N}_{ₚ}_{ⁱ}ⁱ consists of u_{t,t+N}_{_{C}}_{ⁱ}^{i l and u}_{t,t+N}_{_{c}}_{ⁱ}_{+-N}_{_{p−1}}_{ⁱ}ⁱ The latter part is generated by a local terminal control law uⁱ=k_{f}ⁱ(\tilde{x}ₗⁱ), while the former is finite horizon optimal control u_{t,t+N}_{ₚ}_{ⁱ}ⁱ, which is the solution of the optimization problem (4). Now, in spite of the agents being dynamically decoupled, states of other agents in the multi-agent system affect the control of agent Aⁱ by virtue of the information vector \tilde{w}ⁱ being part of its NMPC cost function (54). Therefore, even though the agents are decoupled in the open loop, their dynamics is coupled in close loop due to cooperation cost component in distributed cost (54). Plots 2500 of FIG. 25 illustrate normalized cost of each vehicle in a 3 vehicle fleet. The spikes in cost occur when collision avoidance is active. The exemplary minimum separation of 5 units is not violated. Thus, the closed loop form of the open loop agent dynamics (45) is:

xₜ₊₁ⁱ=fⁱ(xₜ¹, uₜⁱ, wₜⁱ), ∀t≧0, i=1, . . . , N. (55)

We assume that our model of agent dynamics is not perfect, such that the nominal model used for control synthesis is:

\tilde{x}ₜ₊₁ⁱ=f̅¹(\tilde{x}ₜⁱ, uₜⁱ, wₜⁱ), (56)

where, the actual state of the system is xₜⁱ, while the state predicted by model (49) is \tilde{x}ₜⁱ. This system model mismatch leads to agent transition uncertainty such that:

\tilde{f}ⁱ(xₜ, uₜ, wₜ)=fⁱ(xₜ, uₜ, wₜ)+eₓ_{ₜ}ⁱ, eₓⁱ≦|eₓ_{ₜ}ⁱ|≦eₓ¹. (57)

Now, due to uncertainty, the constraint sets (5.2) and (5.6) for xⁱ and wⁱwill be ‘larger’ than constraint sets for \tilde{x}ⁱ, and \tilde{w}ⁱ, such that:

\tilde{x}ₜ ∈ \tilde{X}ₜⁱ(ēₓⁱ,\tilde{ξ}ₓⁱ, e_{w}ⁱ, ξ̅_{w}ⁱ) ⊂ Xⁱ, uₜ ∈ U, \tilde{w}ₜⁱ ∈ \tilde{W}ₜⁱ(ē_{w}ⁱ, ξ̅_{w}ⁱ) ⊂ Wⁱ (58)

Distributed finite horizon optimal control problem (OCP (4)): At every instant t≧0, given prediction and control horizonsNₚⁱ, N_{c}ⁱ ∈ [symbol] _{≧0} terminal control k_{f}ⁱ(\tilde{x}ⁱ): Rⁿ→R^{m}, state estimate \tilde{x}ₜⁱ and information vector approximation \tilde{w}_{t+N}_{ₚ}_{ⁱ}ⁱ, find the optimal control sequence u_{t,t+N}_{_{C−1}}⁰^{ⁱ} that minimizes the finite horizon cost 5.26:

$${u}_{t , t + {N}_{C - 1}}^{{0}^{i}} = {arg min}_{u ∈ U} {J}_{t} ( \tilde{x} , {\tilde{w}}_{t , t + {N}_{p}} , {u}_{t , t + {N}_{p}} , {N}_{c} , {N}_{p} ) , \qquad ( 59 )$$

subject to (I.) nominal state dynamics (56), (II) nominal information vector dynamics (52), (III) tightened constraint sets (58), (IV) Terminal state \tilde{x}_{t+N}_{ₚ}ⁱ is constrained to an invariant terminal set X_{f}ⁱ ∈ \tilde{X}_{t+N}_{_{c}}ⁱ, i.e.:

\tilde{x}ₜ₊ₗⁱ ∈ X_{f}ⁱ, ∀l=N_{C}ⁱ, . . . , Nₚⁱ (60)

The loop is closed by implementing only the first element of u_{t,t+N}_{_{c}}ⁱ₋₁⁰^{ⁱ} at each instant such that the NLMPC control law becomes:

Θₜⁱ(\tilde{x}ⁱ, \tilde{w}ⁱ)=uₜ⁰^{ⁱ}(\tilde{x}ₜⁱ, \tilde{w}ₜⁱ, Nₚⁱ, N_{C}ⁱ), (61)

and the closed loop dynamics becomes:

xₜ₊₁ⁱ=f(xₜⁱ, Θₜⁱ(\tilde{x}ⁱ, \tilde{w}ⁱ), wₜⁱ)=f_{C}ⁱ(xₜⁱ, wₜⁱ), (62)

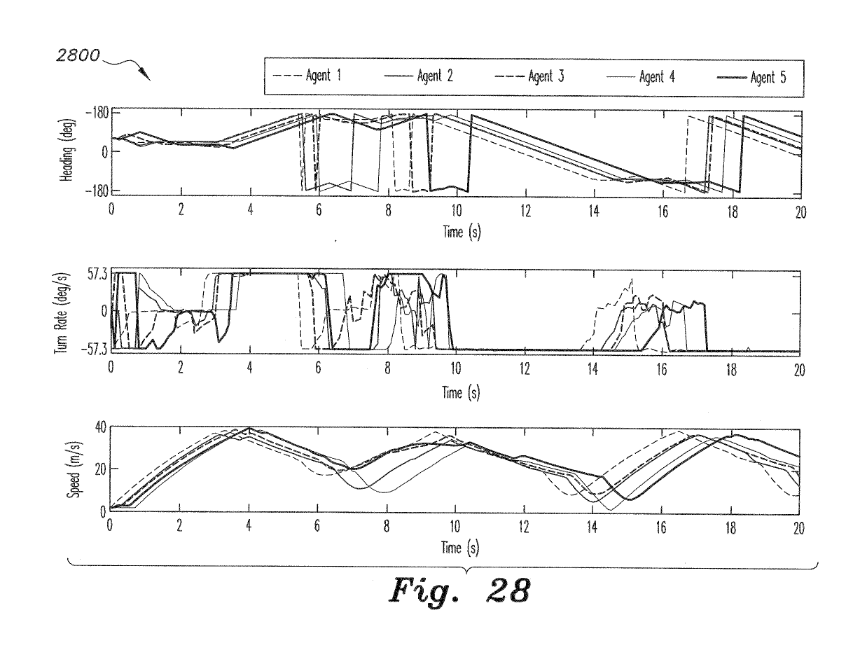

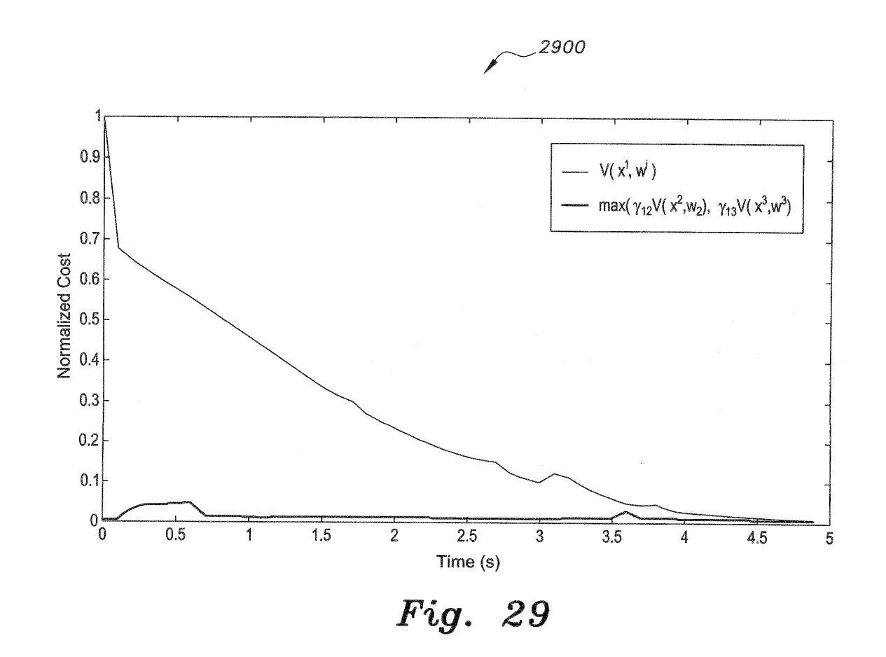

with local closed loop nonlinear map f_{C}ⁱ(x, w). This process is repeated every sampling instant, as illustrated in state and control plots 200 of FIG. 2. To summarize, at time t, each agent Aⁱ (i=1, . . . , N) estimates its local state \tilde{x}ₜⁱ and receives an approximation of the information vector from its neighbors. Then, cost (54) is minimized over the finite horizon using the control adjustments and pre-computed terminal control law subject to constraints (58) and (60). Only the first element of this optimized control sequence is implemented. Then the cycle is repeated at the next sampling instant. The pictorial diagram 2600 indicates a network topology of a weakly connected team with one way communication between agents A⁴ and A⁵. Pictorial graph 2700 illustrates a fleet of 5 robots connected in a weakly connected network in a V-formation. Note the successful collision avoidance. Plots 2800 of FIG. 28 illustrate states of agents connected in the weakly connected network. Plot 2900 of FIG. 29 indicates a small gain condition for the first agent in the weakly connected team (design function parameter k1=5000) for a team of agents with dynamics controlled under eqn. (62). Regarding stability of individual agents with collision avoidance, for an agent on collision course, the optimal trajectory \acute{x}_{t,t+N}_{ₚ}_{ⁱ}ⁱ^{⁰} for cost (54) is modified as cost:

\tilde{J}ₜⁱ=Jₜⁱ(1+φₜⁱ). (63)

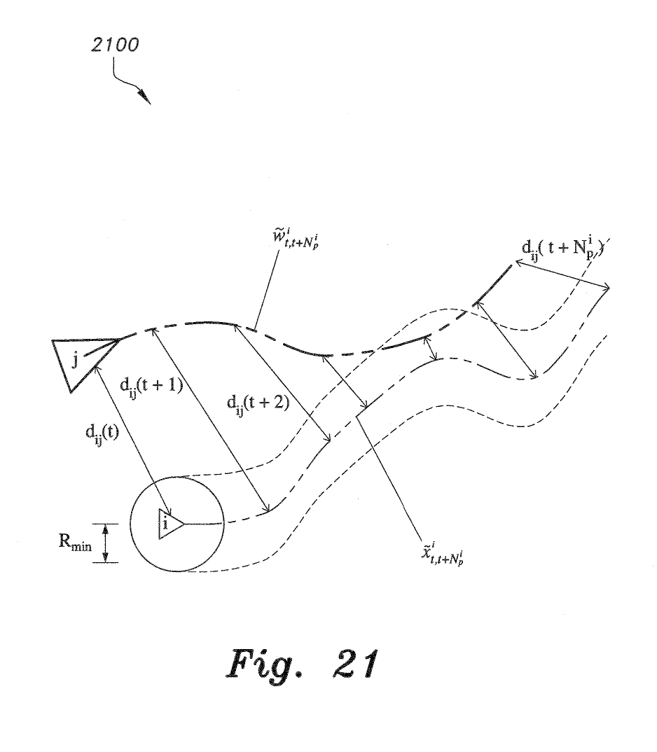

A collision course 2100 as illustrated in FIG. 21 is defined as an agent Aⁱ to be on collision course with at least one other agent, i.e.:

$${\sum }_{j ɛ {G}^{i}} {1}_{Rimin - dijk > 0 , ∀ t \leq k \leq t + {N}_{p}^{i}} > 0 , ∀ j \neq i \qquad ( 64 )$$

where Rₘᵢₙ safety zone of an agent and dijk is thhe Euclidan distance between two agents, the summation representing the total number of agents in collision course with agent Aⁱ. The repelling potential is formulated as:

$${φ}_{t}^{i} = {\sum }_{j ɛ {G}^{i}} \frac{\overline{λ} {1}_{Rimin - dijk > 0 , ∀ t \leq k \leq t + {N}_{p}^{i}}}{{\sum }_{k = t}^{t + {N}_{p}^{i}} λ ( {d}_{k}^{ij} ) {d}_{k}^{ij}} . \qquad ( 65 )$$

Successful collision avoidance occurs if weighted average distance between the agents on collision course is increased during the next time instant i.e.:

$${\sum }_{k = t}^{t + {N}_{p}^{i}} λ ( {d}_{k}^{ij} ) {d}_{k}^{ij} < {\sum }_{k = t + 1}^{t + {N}_{p}^{i} + 1} λ ( {d}_{k}^{ij} ) {d}_{k}^{ij} . \qquad ( 66 )$$

For an agent on collision course the optimal trajectory with modified cost will avoid the collision while maintaining input-to-state practical stability if the repulsive spatial filter weights are computed at each sampling instant t as follows:

$$\frac{{λ}_{max , t}^{i}}{{λ}_{min , t}^{i}} < \frac{{\underline{r}}^{i} ( \vert {x}_{t} \vert )}{\begin{matrix}( ( {N}_{p}^{i} - 1 ) ( {L}_{hx}^{i} + {L}_{qx}^{i} ) + {L}_{hf} ) \\ ( {N}_{p}^{i} {R}_{min} + {N}_{p}^{i} ( {N}_{p}^{i} - 1 ) {v}_{max} )\end{matrix}} {=}^{△} {\overline{a}}_{t} . \qquad ( 67 )$$

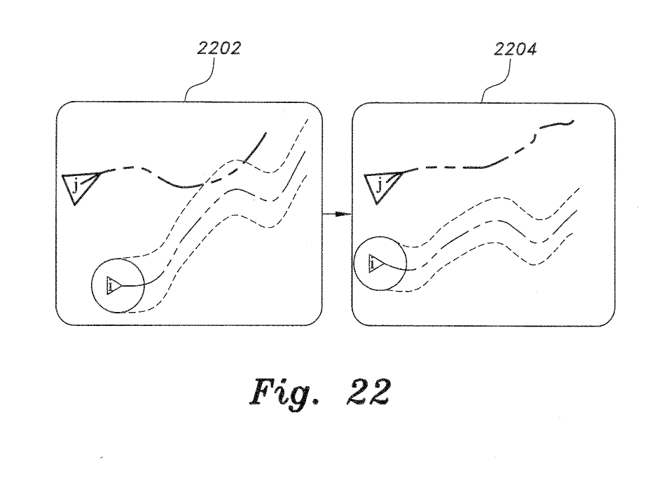

Successful collision avoidance is illustrated in FIG. 22 where in map 2202 the agents were on a collision course, but the collision avoidance component of the present method pushed them away from collision as indicated in map 2204.

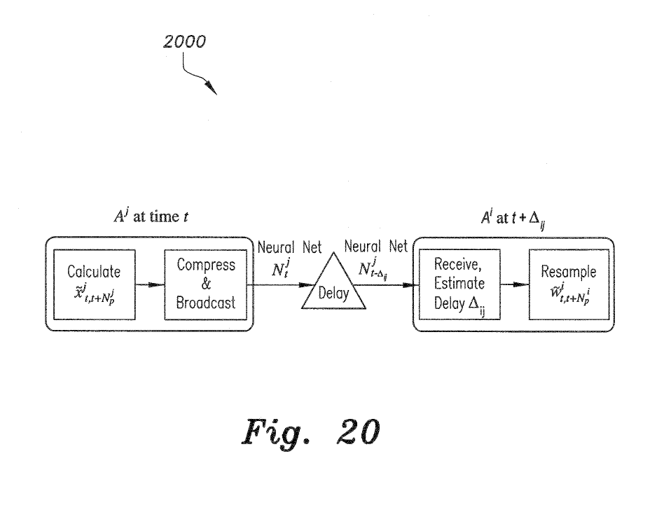

With respect to neural network based trajectory compression, for cooperation, agents transmit their planned state trajectories as mentioned supra. These communication packets are received by vehicles within the neighborhood of transmitting agents. Neighborhood may be defined based on communication range, number of channels on receiving agents etc. With reference to neural network compression 2000 of FIG. 20, a trajectory compressed at Agent A^{j} is transmitted to Agent Aⁱ, where it is received after delay Δᵢⱼ and recovered using the neural network. An exemplary communications packet is shown in Table 7.

TABLE 7
Anatomy of a Typical Communication Packet

| Data Register | Data |
|---|---|
| 1 | Agent identity, i |
| 2 | Time stamp, Tₛⁱ |
| 3 | Sampling time, Tⁱ |
| 4 to 3 + qⁱ | Neural network, Nⁱ |
| 4 + qⁱ onwards | Error correcting codes |
| Optional (leader) | Cooperation Goals |

To reduce packet size, this trajectory containing nⁱ×Nₚⁱ floating points is compressed by approximating it with neural network Nⁱ of qⁱ weights and biases, with compression factor C_{w}ⁱ of

$${C}_{w}^{i} = 1 - \frac{{q}^{i} + overhead size}{{n}^{i} \times {N}_{p}^{i}} . \qquad ( 68 )$$

Tail recovery of a useful part of the trajectory at reception time t is accomplished by tail prediction as follows:

\tilde{w}_{t+N}_{ₚ}_{ⁱ}_{-Δ}_{ᵢⱼ}₊₁ⁱ=\tilde{g}ⁱ(\tilde{w}_{t+N}_{ₚ}_{ⁱ}_{-Δ}_{ᵢⱼ}ⁱ), . . . \tilde{w}_{t+N}_{ₚ}_{ⁱ}ⁱ=\tilde{g}ⁱ(\tilde{w}_{t+N}_{ₚ}_{ⁱ}₋₁ⁱ) (69)

Preferred neural network for this computation is a two layer NN although other NN topologies are contemplated by the present method.

The Distributed NMPC Algorithm for Formation Control procedure is summarized in Table 8.

TABLE 8
Algorithm 7 Distributed NMPC Algorithm for Formation Control

| 1: | procedure OFFLINE CONVEX and MIN-MAX OPTIMIZATION. | |
|---|---|---|
| 2: | | $Input {A}^{1} 1 , {A}^{i} ← {\tilde{x}}_{t}^{i} , {d}^{{h}^{i}} , {d}^{{q}^{i}} , {g}^{i} ⊲ i = 1 {=}^{Δ} Leader , t = 0 ,$ |
| 3: | | Tighten constraints with Algorithm 8 |
| 4: | | Compute Q_{f}ⁱ, K_{f}ⁱ using Algorithms 3 and 4 |
| 5: | | Compute Output deasibility set X_{MPC}ⁱ and controlability sets C₁(X_{f}ⁱ) |
| | using Algorithms 5 and 6 | |
| 6: | end procedure | |
| 7: | procedure DISTRIBUTED ONLINE RH OPTIMIZATION | |
| 8: | | Design Spatially filtered potential (67) |
| 9: | | Solve Problem ECP (4) at Aⁱ for Q_{t,t+N}_{_{C−1}}_{ⁱ}^{ⁱ⁰} |
| 10: | | Train NN Train Neural network for \tilde{x}_{t,t+N}_{ₚ}ⁱ^{⁰} |
| 11: | | Implement first element/block of Q_{t,t+N}_{_{C−1}}_{ⁱ}^{ⁱ⁰} |
| 12: | | Transmit/Receive data packets |
| 13: | | Estimate time delay Δᵢⱼ |
| 14: | | Reconstruct \tilde{w}_{t,t+N}_{ₚ}_{ⁱ}^{ⁱ} with received NN and estimate tail if received |

trajectory (69). Increment time by one sample [symbol] tⁱ = tⁱ + Tⁱ

Multi-agent prediction error bounds are analogous to the single agent prediction error bounds developed supra. With actual constraints Xⁱ and Wⁱ, the tightened constraints are given by:

$$\begin{matrix}{\tilde{X}}_{t + l}^{i} {=}^{△} {X}^{i} \sim {β}^{{n}^{i}} ( {\overline{ρ}}_{{x}_{t + l}}^{i} ) , & ( 70 ) \\ and & \\ {\tilde{W}}_{t + l}^{i} {=}^{△} {W}^{i} \sim {β}^{{p}^{i}} ( {\overline{ρ}}_{{w}_{t + l}}^{i} ) , & ( 71 )\end{matrix}$$

The prediction error bound \tilde{ρ}ⁱₓis defined as:

$$\begin{matrix}{\overline{ρ}}_{{x}_{t + l}}^{i} {=}^{△} {L}_{fx}^{{i}^{l}} {\overline{ξ}}_{x}^{i} + {\overline{e}}_{x}^{i} \frac{{L}_{fx}^{{i}^{l}} - 1}{{L}_{fx}^{i} - 1} , & ( 72 ) \\ and & \\ {\overline{ρ}}_{{w}_{t + l}}^{i} {=}^{△} {\sum }_{j ɛ {G}^{i}} {\vert {w}_{t + 1}^{i} - {\tilde{w}}_{t + 1}^{i} \vert}_{j} . & ( 73 )\end{matrix}$$

The constraint tightening procedure for multi-agents distributed processing is summarized in Table 9.

TABLE 9
Algorithm 8 Agent Constraint Tightening

| | |
|---|---|
| 1: | Given i nominal models \tilde{f}^{l}(\tilde{x}ⁱ,uⁱ\tilde{w}ⁱ), \tilde{g}ⁱ (\tilde{w}ⁱ), uncertainty bounds ξ̅_{w}ⁱ, |
| | ξ̅ₓⁱ, ēₓⁱ, ē_{w}ⁱ, and horizons N_{C}ⁱ, N_{P}ⁱ. |
| 2: | procedure CONSTRAINT TIGHTENING |
| 3: | Calculate Lipschitz constants of nonlinear maps \tilde{f}^{l}(\tilde{x}ⁱ,uⁱ\tilde{w}ⁱ) and |
| | \tilde{g}ⁱ (\tilde{w}ⁱ). |
| 4: | Calculate the prediction error bounds in (72) and (73).. |
| 5: | Tighten the constraints by Pontryagin difference as given in |
| | (70)-(71). |
| 6: | end procedure |

It is to be understood that the present invention is not limited to the embodiments described above, but encompasses any and all embodiments within the scope of the following claims.

We claim:

1. A computer-implemented control method for multi-vehicle systems, comprising the steps of:
optimizing trajectories of a plurality of autonomous vehicles (mobile robots);
predicting states of the vehicles;
determining tightened constraints on the vehicle states, the tightened constraints being characterized by the relations:
$${\tilde{X}}_{t + l}^{i} {=}^{△} {X}^{i} \sim {β}^{{n}^{i}} ( {\overline{ρ}}_{{x}_{t + l}}^{i} ) , \\ and$$
$${\tilde{W}}_{t + l}^{i} {=}^{△} {W}^{i} \sim {β}^{{p}^{i}} ( {\overline{ρ}}_{{w}_{t + l}}^{i} ) ;$$
and
estimating new states of the vehicles based on a result of the state-predicting step and the tightened constraints determination step;
wherein a prediction error bound ρ̅ⁱₓ is defined as:
$${\overline{ρ}}_{{x}_{t + 1}}^{i} {=}^{Δ} {L}_{fx}^{{i}^{l}} {\overline{ξ}}_{x}^{i} + {\overline{e}}_{x}^{i} \frac{{L}_{fx}^{{i}^{l}} - 1}{{L}_{fx}^{i}} , \\ and$$
$${\overline{ρ}}_{{w}_{t + 1}}^{i} {=}^{Δ} {\sum }_{j ∈ {G}^{i}} {\vert {w}_{t + l}^{i} - {\tilde{w}}_{t + l}^{i} \vert}_{j} .$$

2. The computer-implemented control method for multi-vehicle systems according to claim 1, further comprising the steps of:
inputting a nominal model \tilde{f}(\tilde{x}, u, 0), nominal constraints, a receding horizon (RH) cost, and error bounds;
determining optimized terminal set X_{f} and terminal control k_{f};
warm starting a terminal constraint region;
determining a one-step controllability set C₁(X_{f}) to ensure recursive feasibility;
determining a robust output feasibility set X_{MPC};
measuring outputs \tilde{y}ₜ₊₁ and disturbance \tilde{w}ₜ₊₁;
estimating state \tilde{x}ₜ₊ₗ and disturbance \tilde{w}ₜ₊ₗ;
solving finite horizon OCP at t+l for control u_{t+1,t+l,t+N}_{c}⁰; and
implementing a first element of optimized control uₜ^{0.}

3. The computer-implemented control method for multi-vehicle systems according to claim 2, further comprising the steps of:
calculating Lipschitz constants of nonlinear maps \tilde{f}(\tilde{x},u, \tilde{w}) and \tilde{g}(\tilde{w}); and
using the Lipschitz constants in the tightening constraints step of claim 1.

4. The computer-implemented control method for multi-vehicle systems according to claim 3, further comprising the steps of:
selecting S ∈ [symbol] ^{n×n}, such that −q(\tilde{x},\tilde{w})+ψ(\tilde{w})≦\tilde{x}_{c}ⁱ\tilde{S}\tilde{x}, given the nominal model \tilde{f}(\tilde{x},u, 0)), and cost weights Q, R and S;
obtaining initial guess values of Q_{f} as Q_{f}^{∞} and K as K^{∞};
solving a convex optimal control problem (OCP (A)) using parameterized state and control constraints characterized by the relations:
$$[ \begin{matrix}{x}_{t} ∈ X ⋐ {R}^{n} , & X , \{ x : {x}_{min} \leq x \leq {x}_{max} > 0 \} \\ {y}_{t} ∈ Y ⋐ {R}^{q} , & Y , \{ y : {y}_{min} \leq y \leq {y}_{max} > 0 \} \\ {u}_{t} ∈ U ⋐ {R}^{m} , & U , \{ u : {u}_{min} \leq u \leq {u}_{max} > 0 \} \\ {w}_{t} ∈ W ⋐ {R}^{p} , & W , \{ w : {w}_{min} \leq w \leq {w}_{max} > 0 \}\end{matrix} , ]$$
and subject to formulaic computations characterized by the relations:
$${W}_{1} = {W}_{1}^{T} > 0 , \\ a > 0 , \\ [ \begin{matrix}{W}_{1} & {( {A}_{v} {W}_{1} + {B}_{v} {W}_{2} )}^{T} & {{W}_{1} ( Q - \tilde{S} )}^{1 / 2} & {W}_{2}^{T} {R}^{1 / 2} \\ * & {W}_{1} & 0 & 0 \\ * & * & I & 0 \\ * & * & * & I\end{matrix} ] \geq 0 ,$$
for v=1, . . . , v̅,
$$[ \begin{matrix}1 / a & {( {\overline{c}}_{v} {W}_{1} + {\overline{d}}_{v} {W}_{2} )}^{T} \\ * & {W}_{1}\end{matrix} ] \geq 0 ,$$
determining whether X_{f} ⊂ \tilde{X}_{t+N}_{ₚ};
solving (if X_{f} is not a subset of \tilde{X}_{t+N}_{ₚ}) the convex OCP (A) subject to an additional condition characterized by the relation:
$$[ \begin{matrix}- ( Q - ( \overline{S} + \hat{a} {I}_{n} ) ) & {W}_{2}^{T} \\ * & {R}^{- 1}\end{matrix} ] \geq 0 ;$$
and
accepting optimal values of Q_{f}, K and a.

5. The computer-implemented control method for multi-vehicle systems according to claim 4, wherein the warm starting step further comprises the steps of:
solving Riccati equations for vertex values of Q_{f}_{ᵥ}^{∞}, the Riccati equations being a formula characterized by the relation:
Q_{f}_{ᵥ}^{∞}=(Q−\tilde{S})+Aᵥ^{T}(Q_{f}_{ᵥ}^{∞}+Q_{f}_{ᵥ}^{∞}Bᵥ(R+Bᵥ^{T}Q_{f}_{ᵥ}^{∞}Bᵥ)⁻¹Bᵥ^{T}Q_{f}_{ᵥ}^{∞})Aᵥ,
where Q_{f}_{ᵥ}^{∞} is a solution to the discrete-time algebraic Riccati equations (DARE) at each vertex point;
solving convex OCP (2) to obtain Q_{f}^{∞}; and
calculating K^{∞} by solving a formula for Q_{f}^{∞} at A₀ and B₀, the formula being characterized by the relation:
Kᵥ^{∞}=(R+Bᵥ^{T}Q_{f}_{ᵥ}^{∞}Bᵥ)⁻¹Bᵥ^{T}Q_{f}_{ᵥ}^{∞}Aᵥ.

6. The computer-implemented control method for multi-vehicle systems according to claim 5, wherein the one-step controllability set determining step further comprises the steps of:
dividing a boundary of terminal set∂(X_{f}) into Ñ steps;
solving OCP (3) to find points \tilde{x}_{c}ⁱ ∈ ∂ (C₁(X_{f})) for i=1, . . . , N̅; and
calculating a minimum size of C₁(X_{f}) as d̅=min(|\tilde{x}_{c}_{₁}¹−\tilde{x}_{f}¹|, . . . , |\tilde{x}_{c}_{₁}^{N̅}−\tilde{x}_{f}^{Ñ}|) for \tilde{x}_{f}ⁱ ∈ ∂(X_{f}) and i=1, . . . , N̅.

7. The computer-implemented control method for multi-vehicle systems according to claim 6, further comprising the steps of:
determining C₁(X_{f}) by using the steps of claim 6, given as \tilde{x}_{C}_{₁}ⁱ ∈ ∂ (C₁(X_{f})) for i=1, . . . , N̅;
recursively estimating X_{MPC} for l=2, . . . , N_{C} by:
solving OCP (3) with target set C₁(X_{f}) to obtain C₂(X_{f})=C₁(C₁(X_{f})), when l=2;
solving OCP (3) with target set Cₗ₋₁(X_{f}) to obtain Cₗ(X_{f})=C₁(Cₗ₋₁(X_{f})), when l≠2; and
determining X_{MPC} according to a formula characterized by the relation:
X_{MPC}=Uₗ₌₂^{l=N}^{_{c}} C₁(Cₗ₋₁(X_{f})) ∪ C₁(X_{f}) ∪ X_{f}.

8. The computer-implemented control method for multi-vehicle systems according to claim 7, wherein the vehicles are communicating in a network, the method further comprising the steps of:
$$inputting {A}^{1} 1 , {A}^{i} ← {\tilde{x}}_{t}^{i} , {d}^{{h}^{i}} , {d}^{{q}^{i}} , {g}^{i} ⊲ i = 1 {=}^{Δ} Leader , t = 0 ;$$
computing Q_{f}ⁱ, K_{f}ⁱ;
computing output feasibility set X_{MPC}ⁱ and controllability sets C₁(X_{f}ⁱ);
designing a spatially filtered potential according to a formula characterized by the relation:
$$\frac{{λ}_{max , t}^{i}}{{λ}_{min , t}^{i}} < \frac{{\underline{r}}^{i} ( \vert {x}_{t} \vert )}{( ( {N}_{p}^{i} - 1 ) ( {L}_{hx}^{i} + {L}_{qx}^{i} ) + {L}_{hf} ) ( {N}_{p}^{i} {R}_{min} + {N}_{p}^{i} ( {N}_{p}^{i} - 1 ) {v}_{max} )} {=}^{Δ} {\overline{a}}_{t} ;$$
solving OCP (4) at Aⁱfor Q_{t,t+N}_{_{C−1}}_{ⁱ}ⁱ^{⁰};
training a neural network (NN) for \tilde{x}_{t,t+N}_{ₚ}ⁱ^{⁰};
implementing a first element block of u_{t,t+N}_{_{C−1}}_{ⁱ}ⁱ^{⁰};
transmitting and receiving data packets;
estimating a time delay Δᵢⱼ;
reconstructing \tilde{w}_{t,t+N}_{ₚ}_{ⁱ}ⁱ with received NN; and
estimating a tail of received trajectory according to a formula characterized by the relation:
\tilde{w}_{t+N}_{ₚ}_{ⁱ}_{-Δ}_{ᵢⱼ}₊₁ⁱ=\tilde{g}ⁱ(\tilde{w}_{t+N}_{ₚ}_{ⁱ}_{-Δ}_{ᵢⱼ}ⁱ), . . . \tilde{w}_{t+N}_{ₚ}_{ⁱ}ⁱ=\tilde{g}ⁱ(\tilde{w}_{t+N}_{ₚ}_{ⁱ}₋₁ⁱ).

9. A control system for multi-vehicle systems having a plurality of autonomous vehicles (mobile robots), the control system comprising in each of the autonomous vehicles:
an optimizer outputting control signals to the vehicle;
a state predictor connected to the optimizer;
a state estimator connected to the state predictor, the state estimator accepting information about the vehicle's state as input and outputting its estimate to the state predictor; and
means for determining tightened constraints on the vehicle states, the tightened constraints being characterized by the relations:
$${\tilde{X}}_{t + 1}^{i} {=}^{Δ} {X}^{i} \sim {β}^{{n}^{i}} ( {\overline{ρ}}_{{x}_{t + l}}^{i} ) , \\ and$$
$${\tilde{W}}_{t + 1}^{i} {=}^{Δ} {W}^{i} \sim {β}^{{p}^{i}} ( {\overline{ρ}}_{{w}_{t + l}}^{i} ) ;$$
wherein a prediction error bound ρ̅ⁱₓis defined as
$${\overline{ρ}}_{{x}_{t + 1}}^{i} {=}^{Δ} {L}_{fx}^{{i}^{l}} {\overline{ξ}}_{x}^{i} + {\overline{e}}_{x}^{i} \frac{{L}_{fx}^{{i}^{l}} - 1}{{L}_{fx}^{i}} , \\ and$$
$${\overline{ρ}}_{{w}_{t + 1}}^{i} {=}^{Δ} {\sum }_{j ∈ {G}^{i}} {\vert {w}_{t + l}^{i} - {\tilde{w}}_{t + l}^{i} \vert}_{j} .$$

10. The control system for multi-vehicle systems according to claim 9, further comprising:
means for inputting a nominal model \tilde{f}(\tilde{x},u, 0), nominal constraints, a receding horizon (RH) cost, and error bounds;
means for determining optimized terminal set X_{f}and terminal control k_{f};
means for warm starting a terminal constraint region;
means for determining a one-step controllability set C₁(X_{f}) to ensure recursive feasibility;
means for determining a robust output feasibility set X_{MPC};
means for measuring outputs \tilde{y}ₜ₊₁ and disturbance \tilde{w}ₜ₊₁;
means for estimating state \tilde{x}ₜ₊₁ and disturbance \tilde{w}ₜ₊ₗ;
means for solving finite horizon OCP at t+1 for control u_{t+1,t+l,t+N}_{_{c}}⁰; and
means for implementing a first element of optimized control uₜ⁰.

11. The control system for multi-vehicle systems according to claim 10, further comprising:
means for calculating Lipschitz constants of nonlinear maps \tilde{f}(\tilde{x},u,\tilde{w}) and \tilde{g}(\tilde{w}); and
means for using the Lipschitz constants in the tightening constraints step of claim 9.

12. The control system for multi-vehicle systems according to claim 11, further comprising:
means for selecting \tilde{S} ∈ [symbol] ^{n×n}, such that −q(\tilde{x},\tilde{w})+ψ(\tilde{w})≦\tilde{x}_{c}ⁱ\tilde{S}\tilde{x}, given the nominal model \tilde{f}(\tilde{x}, u, 0)), and cost weights Q, R and S;
means for obtaining initial guess values of Q_{f} as Q_{f}^{∞} and K as K^{∞};
means for solving a convex optimal control problem (OCP (A)) using parameterized state and control constraints characterized by the relations:
$$[ \begin{matrix}{x}_{t} ∈ X ⋐ {R}^{n} , & X , \{ x : {x}_{min} \leq x \leq {x}_{max} > 0 \} \\ {y}_{t} ∈ Y ⋐ {R}^{q} , & Y , \{ y : {y}_{min} \leq y \leq {y}_{max} > 0 \} \\ {u}_{t} ∈ U ⋐ {R}^{m} , & U , \{ u : {u}_{min} \leq u \leq {u}_{max} > 0 \} \\ {w}_{t} ∈ W ⋐ {R}^{p} , & W , \{ w : {w}_{min} \leq w \leq {w}_{max} > 0 \}\end{matrix} , ]$$
and subject to formulaic computations characterized by the relations:
$${W}_{1} = {W}_{1}^{T} > 0 , \\ a > 0 , \\ [ \begin{matrix}{W}_{1} & {( {A}_{v} {W}_{1} + {B}_{v} {W}_{2} )}^{T} & {{W}_{1} ( Q - \tilde{S} )}^{1 / 2} & {W}_{2}^{T} {R}^{1 / 2} \\ * & {W}_{1} & 0 & 0 \\ * & * & I & 0 \\ * & * & * & I\end{matrix} ] \geq 0 ,$$
for v=1, . . . , v̅,
$$[ \begin{matrix}1 / a & {( {\overline{c}}_{v} {W}_{1} + {\overline{d}}_{v} {W}_{2} )}^{T} \\ * & {W}_{1}\end{matrix} ] \geq 0 ,$$
means for determining whether X_{f} ⊂ \tilde{X}_{t+N}_{ₚ};
means for solving (if X_{f} is not a subset of \tilde{X}_{t+N}_{ₚ}) the convex OCP (A) subject to an additional condition characterized by the relation:
$$[ \begin{matrix}- ( Q - ( \overline{S} + \hat{a} {I}_{n} ) ) & {W}_{2}^{T} \\ * & {R}^{- 1}\end{matrix} ] \geq 0 ;$$
and
means for accepting optimal values of Q_{f}, K and a.

13. The control system for multi-vehicle systems according to claim 12, further comprising:
means for solving Riccati equations for vertex values of Q_{f}_{ᵥ}^{∞}, the Riccati equations being a formula characterized by the relation:
Q_{f}_{ᵥ}^{∞}=(Q−\tilde{S})+Aᵥ^{T}(Q_{f}_{ᵥ}^{∞}+Q_{f}_{ᵥ}^{∞}Bᵥ(R+Bᵥ^{T}Q_{f}_{ᵥ}^{∞}Bᵥ)⁻¹Bᵥ^{T}Q_{f}_{ᵥ}^{∞})Aᵥ,
where Q_{f}_{ᵥ}^{∞} is a solution to the discrete-time algebraic Riccati equations (DARE) at each vertex point;
means for solving convex OCP (2) to obtain Q_{f}^{∞}; and
means for calculating K^{∞} by solving a formula for Q_{f}^{∞} at A₀ and B₀, the formula being characterized by the relation:
Kᵥ^{∞}=(R+Bᵥ^{T}Q_{f}_{ᵥ}^{∞}Bᵥ)⁻¹Bᵥ^{T}Q_{f}_{ᵥ}^{∞}Aᵥ.

14. The control system for multi-vehicle systems according to claim 13, further comprising:
means for solving OCP (3) to find points \tilde{x}_{c}ⁱ ∈ ∂ (C₁(X_{f})) for i=1, . . . , N̅; and
means for calculating a minimum size of C₁(X_{f}) as d̅=min(|\tilde{x}_{c}_{₁}¹−\tilde{x}_{f}¹|, . . . , |\tilde{x}_{c}_{₁}^{N̅}−\tilde{x}_{f}^{N̅}|) for \tilde{x}_{f}ⁱ ∈ ∂(X_{f}) and i=1, . . . , N̅.

15. The control system for multi-vehicle systems according to claim 14, further comprising:
means for determining C₁(X_{f}) by using the steps of claim 6, given as \tilde{x}_{C}_{₁}ⁱ ∈ ∂ (C₁(X_{f})) for i=1, . . . , N̅;
means for recursively estimating X_{MPC} for l=2, . . . , N_{C} by:
means for solving OCP (3) with target set C₁(X_{f}) to obtain C₂(X_{f})=C₁(C₁(X_{f})), when l=2;
means for solving OCP (3) with target set Cₗ₋₁(X_{f}) to obtain Cₗ(X_{f})=C₁ (Cₗ₋₁(X_{f})) , when i≠2; and
means for determining X_{MPC} according to a formula characterized by the relation:
X_{MPC}=∪ₗ₌₂^{l=N}^{_{c}} C₁(Cₗ₋₁(X_{f})) ∪ C₁(X_{f}) ∪ X_{f}.

16. The control system for multi-vehicle systems according to claim 15, where the vehicles are communicating in a network, further comprising:
means for inputting
$${A}^{1} 1 , {A}^{i} ← {x}_{t}^{i} , {d}^{{h}^{i}} , {d}^{{q}^{i}} , {g}^{i} ⊲ i = 1 {=}^{Δ} Leader , t = 0 ;$$
computing Q_{f}ⁱ, K_{f}ⁱ;
means for computing output feasibility set X_{MPC}ⁱ and controllability sets C₁(X_{f}ⁱ);
means for designing a spatially filtered potential according to a formula characterized by the relation:
$$\frac{{λ}_{max , t}^{i}}{{λ}_{min , t}^{i}} < \frac{{\underline{r}}^{i} ( \vert {x}_{t} \vert )}{( ( {N}_{p}^{i} - 1 ) ( {L}_{hx}^{i} + {L}_{qx}^{i} ) + {L}_{hf} ) ( {N}_{p}^{i} {R}_{min} + {N}_{p}^{i} ( {N}_{p}^{i} - 1 ) {v}_{max} )} {=}^{Δ} {\overline{a}}_{t} ;$$
means for solving OCP (4) at Aⁱ or Q_{t,t+N}_{_{C−1}}ⁱⁱ^{⁰};
means for training a neural network (NN) for \tilde{x}_{t,t+N}_{ₚ}ⁱ^{⁰};
means for implementing a first element block of u_{t,t+N}_{_{C−1}}_{ⁱ}ⁱ^{⁰};
means for transmitting and receiving data packets;
means for estimating a time delay Δᵢⱼ;
means for reconstructing \tilde{w}_{t,t+N}_{ₚ}_{ⁱ}ⁱ with received NN; and
means for estimating a tail of received trajectory according to a formula characterized by the relation:
\tilde{w}_{t+N}_{ₚ}_{ⁱ}_{-Δ}_{ᵢⱼ}₊₁ⁱ=\tilde{g}ⁱ (\tilde{w}_{t+N}_{ₚ}_{ⁱ}_{-Δ}_{ᵢⱼ}ⁱ), . . . \tilde{w}_{t+N}_{ₚ}_{ⁱ}ⁱ=\tilde{g}ⁱ (\tilde{w}_{t+N}_{ₚ}_{ⁱ}₋₁ⁱ).
